(19) United States
(12) Patent Application Publication
(10) Pub. No.: US 2024/0062955 A1
(43) Pub. Date: Feb. 22, 2024

(54) METHOD FOR MANUFACTURING LAMINATE COIL, LAMINATE COIL, COIL DEVICE, AND POWER CONVERSION DEVICE

(71) Applicant: Mitsubishi Electric Corporation, Chiyoda-ku, Tokyo (JP)

(72) Inventors: Kenta FUJII, Chiyoda-ku, Tokyo (JP); Takashi KUMAGAI, Chiyoda-ku, Tokyo (JP); Tomohito FUKUDA, Chiyoda-ku, Tokyo (JP); Shoichiro NISHIZAWA, Sanda-shi, Hyogo (JP)

(73) Assignee: Mitsubishi Electric Corporation, Chiyoda-ku, Tokyo (JP)

(21) Appl. No.: 18/260,521

(22) PCT Filed: Jan. 20, 2022
(86) PCT No.: PCT/JP2022/002017

§ 371 Date: Jul. 6, 2023

(30) Foreign Application Priority Data
Jan. 22, 2021 (JP) 2021-008475

(51) Int. Cl. H01F 41/063; H01F 5/06; H01F 27/02; H01F 41/12

(52) U.S. Cl. CPC H01F 41/063; H01F 5/06; H01F 27/022; H01F 41/12

(57) ABSTRACT

A laminate coil is formed by laminating a plurality of multilayer insulating members such that a first coil, a second coil, and a third coil each formed of a flat conductor are sandwiched between the plurality of multilayer insulating members. In the laminate coil, a through-hole is provided inside the coil in planar view. The plurality of multilayer insulating members adjacent to each other in a multilayer direction are bonded to each other at an inner end of the laminate coil positioned on the through-hole side, and an inside end of each of the first coil, the second coil, and the third coil is sealed by the multilayer insulating member.

### TECHNICAL FIELD

The present disclosure relates to a method for manufacturing a laminate coil, a laminate coil, a coil device including the laminate coil, and a power conversion device.

### BACKGROUND ART

For example, a coil device such as a smoothing coil or a transformer is mounted on a power conversion device such as a DC/DC conversion device. In general, the coil device is configured by winding a coil around a core. In recent years, in order to downsize a transformer that is the coil device, a switching frequency of a switching element mounted on the power conversion device has been increased to, for example, greater than or equal to 1 kHz. Thus, a sectional area of the core can be reduced and the number of turns of the coil can be reduced, so that the transformer can be downsized.

However, when the frequency of switching is made higher in order to downsize the transformer, current density flowing through the coil becomes high on a surface of the coil and becomes low when being away from the surface of the coil due to what is called a skin effect. Thus, the coil has a problem that a conduction loss at the time of current conduction increases. Accordingly, use of a planar coil in which a flat plate-shaped conductor having a large surface area is spirally disposed is known (for example, see PTL 1).

### CITATION LIST

### Patent Literature

PTL 1: Japanese Patent Laying-Open No. 2002-260934

### SUMMARY OF INVENTION

### Technical Problem

PTL 1 describes a planar coil formed by laminating a plurality of layers of windings in which a flat plate-shaped conductor is spirally disposed with an insulating layer interposed therebetween. A planar transformer in which the planar coil and a core are combined is also described. However, in the configuration in which the plurality of layers of windings are laminated with the insulating layer interposed therebetween, positional displacement of the windings and deformation of the windings are likely to be generated due to vibration, expansion or contraction of the windings by heat, or the like. In the planar coil, when the winding is exposed from the insulating layer due to the positional displacement or the deformation of the winding, the winding and the core are brought into contact with each other and short-circuited, which causes a problem of degrading a characteristic of the planar transformer.

The present disclosure has been made focusing on the above problems. An object of the present disclosure is to prevent the degradation of the characteristic of the coil device due to the contact between the coil and the core and the short circuit in a laminate coil formed by laminating the plurality of layers of the coil formed by winding a flat conductor that is a flat conductor with an insulating member interposed therebetween.

### Solution to Problem

A method for manufacturing a laminate coil according to the present disclosure is a method for manufacturing a laminate coil formed by laminating a first coil and a second coil, a first multilayer insulating member, a second multilayer insulating member, and a third multilayer insulating member, each of the first coil and the second coil being formed of a flat conductor, the method including: (a) sequentially laminating the first multilayer insulating member, the first coil, the second multilayer insulating member, the second coil, and the third multilayer insulating member and forming a multilayer body so as to include a through-hole penetrating, in a multilayer direction, into the first coil and the second coil in planar view; (b) disposing a pair of first pressing elastic members so as to sandwich an inner end of the multilayer body in the multilayer direction, the inner end being located on a through-hole side and, further, preparing a pair of pressing members so as to sandwich the pair of first pressing elastic members; and (c) applying pressure between the pair of pressing members to bond, at the inner end, the first multilayer insulating member and the second multilayer insulating member, and the second multilayer insulating member and the third multilayer insulating member, and sealing an inside end of each of the first coil and the second coil, the inside end being located on the through-hole side.

A laminate coil according to the present disclosure includes: a plurality of coils formed of flat conductors; and a plurality of multilayer insulating members, in which a laminate coil in which each of the plurality of coils is laminated so as to be sandwiched between the plurality of multilayer insulating members, the laminate coil being formed so as to include a through-hole penetrating, in a multilayer direction, into the plurality of coils in planar view, the plurality of multilayer insulating members adjacent to each other in the multilayer direction are bonded to each other at an inner end located on a through-hole side, and an inside end located on the through-hole side in each of the plurality of coils is sealed.

### Advantageous Effects of Invention

The coil device of the present disclosure including the laminate coil can prevent the degradation of the characteristic of the coil device due to the short circuit between the coil and the core.

### BRIEF DESCRIPTION OF DRAWINGS

FIG. 1 is a circuit diagram illustrating a configuration of a power conversion device 1 according to each embodiment.

FIG. 2 is a schematic perspective view illustrating a configuration of a coil device 101 according to a first embodiment.

FIG. 3 is a schematic plan view illustrating the configuration of coil device 101 of the first embodiment.

FIG. 4 is a schematic sectional view taken along a sectional line A-A in FIG. 3.

FIG. 5 is a schematic sectional view taken along a sectional line B-B in FIG. 3.

FIG. 6 is a schematic plan view illustrating a configuration of laminate coil 30 of the first embodiment.

FIG. 7 is a schematic sectional view taken along a sectional line C-C in FIG. 6.

FIG. 8 is a schematic sectional view illustrating a configuration of a laminate coil 30A when a number of laminated coils is an even number.

FIG. 9 is a schematic plan view illustrating a configuration of a first coil 20 of the first embodiment.

FIG. 10 is a schematic plan view illustrating a configuration of a second coil 21 of the first embodiment.

FIG. 11 is a schematic plan view illustrating a configuration of a third coil 22 of the first embodiment.

FIG. 12 is a schematic plan view illustrating a configuration of a deformation coil 25 of the first embodiment.

FIG. 13 is a schematic plan view illustrating a configuration of a multilayer body 31 of the first embodiment.

FIG. 14 is a schematic sectional view taken along a sectional line D-D in FIG. 13.

FIG. 15 is a schematic perspective view illustrating a second step of a method for manufacturing the laminate coil 30 of the first embodiment.

FIG. 16 is a schematic perspective view illustrating a third step and a fourth step of the method for manufacturing laminate coil 30 of the first embodiment.

FIG. 17 is a schematic sectional view taken along a sectional line E-E in FIG. 16.

FIG. 18 is a schematic sectional view illustrating a configuration of a laminate coil 30B according to a first modification of the first embodiment.

FIG. 19 is a schematic sectional view illustrating a configuration of a multilayer body 31C according to a second modification of the first embodiment.

FIG. 20 is a schematic sectional view illustrating a configuration of a laminate coil 30C of the second modification of the first embodiment.

FIG. 21 is a schematic sectional view illustrating a configuration of a laminate coil 30D according to a third modification of the first embodiment.

FIG. 22 is a schematic sectional view illustrating a configuration of a coil device 101E according to a second embodiment.

FIG. 23 is a schematic plan view illustrating a configuration of a laminate coil 30E of the second embodiment.

FIG. 24 is a schematic sectional view taken along a sectional line F-F in FIG. 23.

FIG. 25 is a schematic plan view illustrating a configuration of a multilayer body 31E of the second embodiment.

FIG. 26 is a schematic sectional view taken along a sectional line G-G in FIG. 25.

FIG. 27 is a schematic perspective view illustrating a second step of a method for manufacturing the laminate coil 30E of the second embodiment.

FIG. 28 is a schematic perspective view illustrating a third step and a fourth step of the method for manufacturing laminate coil 30E of the second embodiment.

FIG. 29 is a schematic sectional view taken along a sectional line H-H in FIG. 28.

FIG. 30 is a schematic sectional view illustrating a configuration of a laminate coil 30F according to a first modification of the second embodiment.

FIG. 31 is a schematic sectional view illustrating a configuration of a multilayer body 31G according to a second modification of the second embodiment.

FIG. 32 is a schematic sectional view illustrating a configuration of a laminate coil 30G of the second modification of the second embodiment.

FIG. 33 is a schematic sectional view illustrating a configuration of a laminate coil 30H according to a third modification of the second embodiment.

### DESCRIPTION OF EMBODIMENTS

### First Embodiment

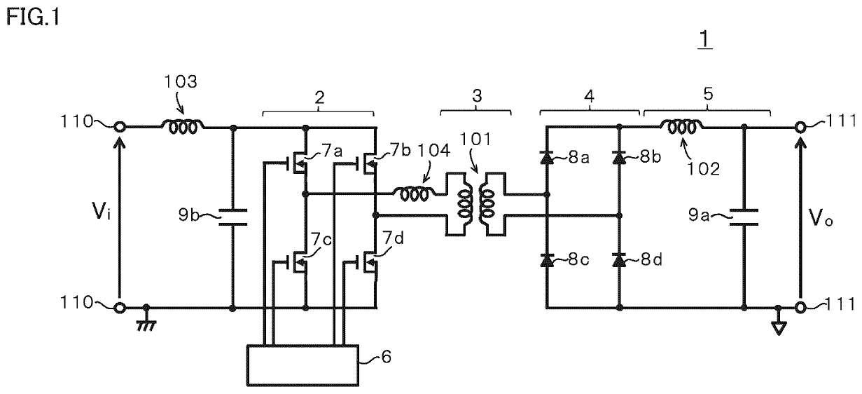

FIG. 1 is a circuit diagram illustrating a configuration of a power conversion device 1 according to each embodiment. Here, power conversion device 1 illustrates a DC/DC conversion device as an example. However, for example, power conversion device 1 may be a device that converts an AC voltage, such as an AC/DC conversion device or an AC/AC conversion device. As illustrated in FIG. 1, power conversion device 1 includes an inverter circuit 2, a transformer circuit 3, a rectifier circuit 4, a smoothing circuit 5, and a control circuit 6. Power conversion device 1 converts a DC voltage Vi input from an input terminal 110 into a DC voltage Vo, and outputs DC voltage Vo at an output terminal 111.

Inverter circuit 2 includes four switching elements 7a, 7b, 7c, 7d. For example, in FIG. 1, switching element 7a and switching element 7c connected in series and switching element 7b and switching element 7d connected in series are connected in parallel. Each of switching elements 7a, 7b, 7c, 7d is a metal oxide semiconductor field effect transistor (MOSFET), an insulated gate bipolar transistor (IGBT), or the like. For example, each of switching elements 7a, 7b, 7c, 7d is made of any one of silicon (Si), silicon carbide (SiC), and gallium nitride (GaN).

Transformer circuit 3 includes a coil device 101 as a transformer. Coil device 101 includes a laminate coil 30. For example, laminate coil 30 includes a plurality of sheet-like or film-like multilayer insulating members 32, a first coil 20, a second coil 21, and a third coil 22. Here, for example, third coil 22 is connected in parallel with first coil 20. First coil 20 and third coil 22 are primary side coils connected to inverter circuit 2, namely, high voltage-side coils. Second coil 21 is a secondary coil connected to rectifier circuit 4, namely, a low voltage-side coil. The configuration of coil device 101 is not limited thereto.

Rectifier circuit 4 includes four diodes 8a, 8b, 8c, 8d. For example, in FIG. 1, diode 8a and diode 8c that are connected in series and diode 8b and diode 8d that are connected in series are connected in parallel. For example, each of diodes 8a, 8b, 8c, 8d is made of any one of silicon (Si), silicon carbide (SiC), and gallium nitride (GaN).

Smoothing circuit 5 includes a coil device 102 as a smoothing coil and a capacitor 9a. Control circuit 6 has a role of outputting a control signal controlling inverter circuit 2 to inverter circuit 2. Inverter circuit 2 converts an input voltage and outputs the converted voltage.

For example, power conversion device 1 includes a coil device 103 as the smoothing coil and a capacitor 9b at a preceding stage of inverter circuit 2. For example, power conversion device 1 includes a coil device 104 as a resonance coil between inverter circuit 2 and transformer circuit 3. More specifically, one end of coil device 104 is connected between switching element 7a and switching element 7c. The other end of coil device 104 is connected between first coil 20 and third coil 22 that are connected in parallel.

For example, a DC voltage Vi greater than 100 V or and less than or equal to 600 V is input to power conversion device 1. For example, power conversion device 1 outputs a DC voltage Vo greater than 12 V and less than or equal to 600 V. Specifically, DC voltage Vi input to input terminal 110 of power conversion device 1 is converted into a first AC voltage by inverter circuit 2. The AC voltage is converted into a second AC voltage lower than the first AC voltage by transformer circuit 3. The second AC voltage is rectified by rectifier circuit 4. Smoothing circuit 5 smooths the voltage output from rectifier circuit 4. Power conversion device 1 outputs DC voltage Vo output from smoothing circuit 5 from output terminal 111. Here, DC voltage Vi may be greater than or equal to DC voltage Vo.

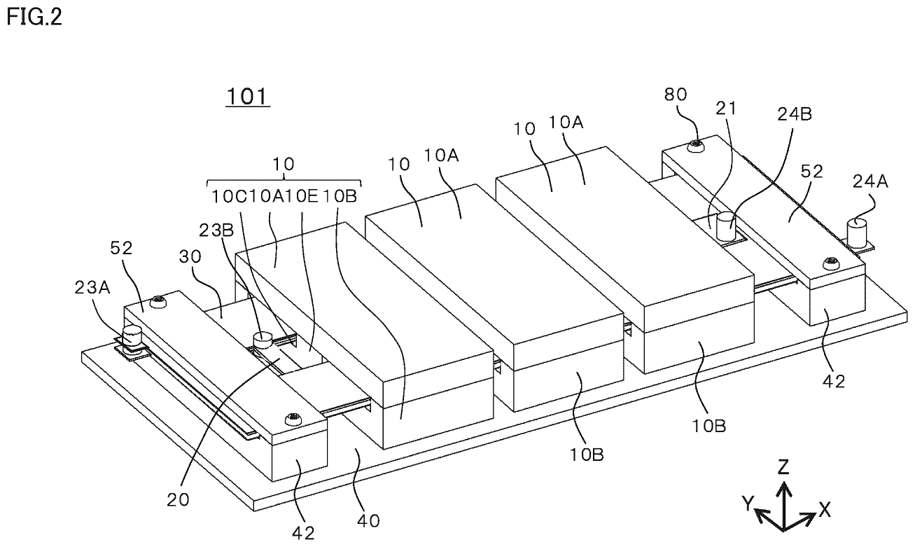

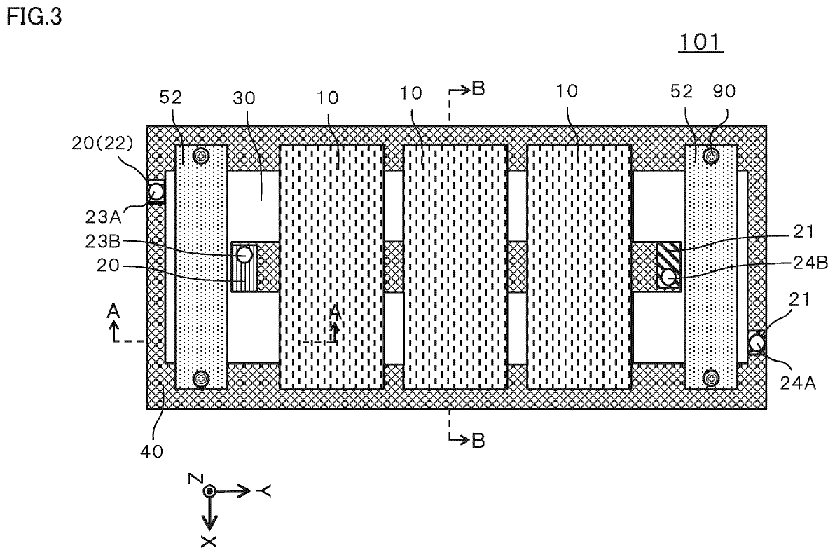

With reference to FIGS. 2 to 12, configurations of coil device 101 included in the power conversion device and laminate coil 30 included in coil device 101 of the first embodiment will be described below.

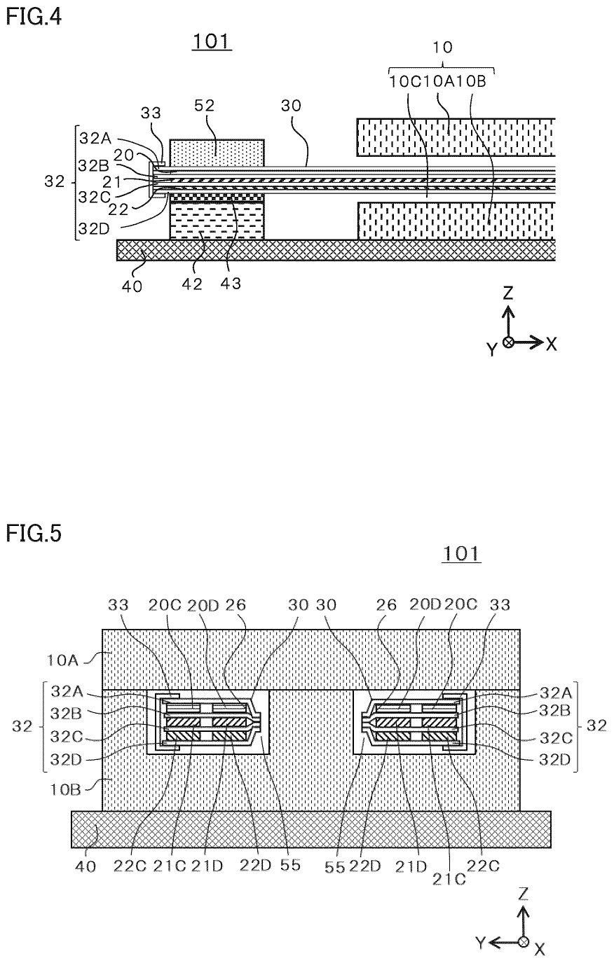

With reference to FIGS. 2 to 5, coil device 101 of the first embodiment will be described. Coil device 101 includes a laminate coil 30, a core 10, a protrusion member 42, and a fixing member 52. In addition, for example, these are mounted on the surface of a support 40. As illustrated in FIG. 4, laminate coil 30 is sandwiched between protrusion member 42 and fixing member 52, and is fixed to protrusion member 42 using, for example, a screw 90. When a heat transfer member 43 is disposed between laminate coil 30 and protrusion member 42, heat of laminate coil 30 is easily radiated to support 40.

Here, support 40 preferably has a thermal conductivity greater than or equal to 0.1 W/(m·K). In addition, support 40 is preferably formed of a material having high rigidity. Specifically, support 40 is formed of any metal material selected from copper (Cu), aluminum (Al), iron (Fe), an iron alloy such as SUS304, a copper alloy such as phosphor bronze, and an aluminum alloy such as ADC12.

Alternatively, support 40 may be made of a resin material containing a thermally conductive filler. Here, for example, the resin material is any one selected from polybutylene terephthalate (PBT), polyphenylene sulfide (PPS), and polyetheretherketone (PEEK). When being integrated with support 40, protrusion member 42 is made of the same material as support 40. When being separate from support 40, protrusion member 42 may be the same material as support 40 or be a material different from support 40.

For example, core 10 includes an upper core 10A and a lower core 10B including a wound portion 10E, and a void portion 10C is provided in a part between upper core 10A and lower core 10B. In coil device 101, laminate coil 30 is provided so as to penetrate void portion 10C provided between upper core 10A and lower core 10B. As illustrated in FIG. 2, a plurality of cores 10 are provided at intervals in an X-direction that is a long-side direction of laminate coil 30. However, the present disclosure is not limited thereto, and coil device 101 may include one core 10. For example, core 10 is formed of a ferrite core such as a manganese-zinc (Mn—Zn)-based ferrite core or a nickel-zinc (Ni—Zn)-based ferrite core. Alternatively, for example, core 10 may be what is called an amorphous core or what is called an eye-dust core. The amorphous core is formed of an iron-based amorphous alloy. The iron dust core is an iron powder that is pressure-molded.

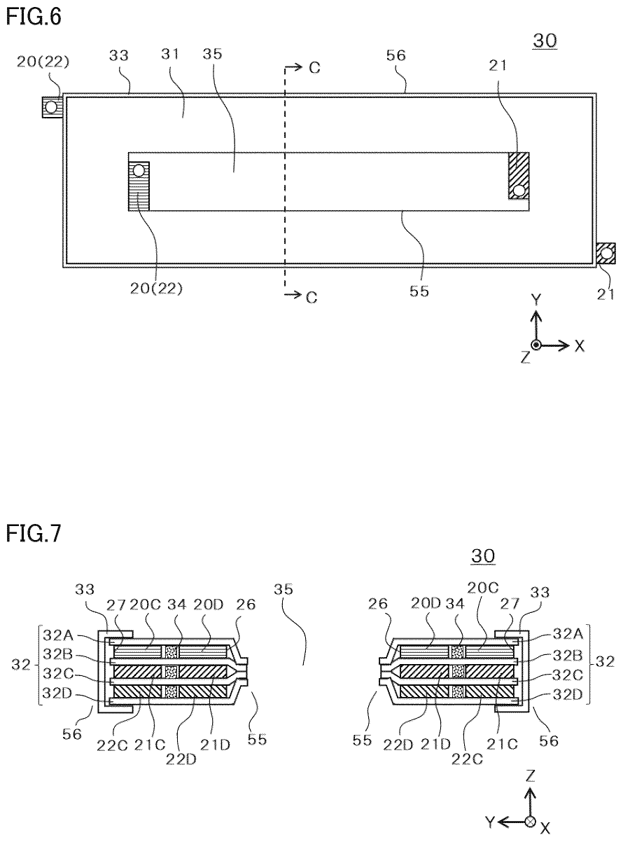

With reference to FIGS. 6 and 7, laminate coil 30 included in coil device 101 of the first embodiment will be described below. Laminate coil 30 includes a first coil 20, a second coil 21, and a third coil 22 that are formed by winding a flat conductor that is a conductor having a flat plate shape, and a plurality of multilayer insulating members 32 such as sheet-like or film-like first multilayer insulating member 32A, second multilayer insulating member 32B, third multilayer insulating member 32C, and fourth multilayer insulating member 32D. Here, the number of coils included in laminate coil 30 and the number of multilayer insulating members 32 are not limited thereto.

As illustrated in FIG. 6, laminate coil 30 has a shape having a relatively large surface area in planar view from a Z-direction. In other words, laminate coil 30 extends along an XY-plane and has a generally rectangular flat plate shape including a plurality of straight portions and a plurality of corner portions. However, the shape is not limited to the rectangle, and for example, may be an elliptical shape extending on the XY-plane or a circular flat plate shape. Laminate coil 30 has a shape including a through-hole 35 penetrating the plurality of laminated coils and the plurality of multilayer insulating members 32 in the Z-direction that is a multilayer direction inside the coil in planar view.

As illustrated in FIG. 7, laminate coil 30 has a multilayer structure in which first multilayer insulating member 32A, first coil 20, second multilayer insulating member 32B, second coil 21, third multilayer insulating member 32C, third coil 22, and fourth multilayer insulating member 32D are laminated in this order in the Z-direction that is the multilayer direction. In other words, laminate coil 30 has the multilayer structure in which first coil 20, second coil 21, and third coil 22 are arranged so as to be sandwiched between the plurality of multilayer insulating members 32 and are laminated and formed in the Z-direction.

At an inner end 55 of laminate coil 30, the plurality of multilayer insulating members 32 adjacent to each other in the Z-direction that is the multilayer direction are bonded to each other. Specifically, first multilayer insulating member 32A and second multilayer insulating member 32B are bonded to each other at inner end 55 of laminate coil 30. Second multilayer insulating member 32B and third multilayer insulating member 32C are bonded to each other. Third multilayer insulating member 32C and fourth multilayer insulating member 32D are bonded to each other. Here, inner end 55 of laminate coil 30 is an end of laminate coil 30 located on a through-hole 35 side in planar view.

Thus, an inside end 26 of each of first coil 20, second coil 21, and third coil 22 is shut tightly by the plurality of multilayer insulating members 32. In other words, inside end 26 of each of first coil 20, second coil 21, and third coil 22 is sealed by the plurality of multilayer insulating members 32. Here, inside end 26 of each of first coil 20, second coil 21, and third coil 22 is an end located on the through-hole 35 side in each of first coil 20, second coil 21, and third coil 22 in planar view.

In an outer end 56 of laminate coil 30, outside ends 27 of first coil 20, second coil 21, and third coil 22 are covered with an insulating sealing member 33 such as an insulating tape. Outside ends 27 of first coil 20, second coil 21, and third coil 22 may be sealed by insulating sealing member 33. Insulating sealing member 33 is not limited to the insulating tape.

Here, outer end 56 of laminate coil 30 is an end located in a direction opposite to inner end 55 on the through-hole 35 side in laminate coil 30 in planar view. Outside ends 27 of first coil 20, second coil 21, and third coil 22 are ends located in the direction opposite to inside end 26 that is on the through-hole 35 side in first coil 20, second coil 21, and third coil 22 in planar view.

Furthermore, as illustrated in FIG. 7, for example, an inter-conductor insulating member 34 may be disposed between a first turn 20C and to second turn 20D in first coil 20. This prevents a short circuit between first turn 20C and second turn 20D. Furthermore, for example, inter-conductor insulating member 34 may be disposed between a first turn 21C and a second turn 21D of second coil 21. This prevents the short circuit between first turn 21C and second turn 21D. Furthermore, for example, inter-conductor insulating member 34 may be disposed between a first turn 22C and a second turn 22D of third coil 22. This prevents the short circuit between first turn 22C and second turn 22D. On the other hand, like laminate coil 30 in FIG. 5, inter-conductor insulating member 34 may not be disposed.

Here, inter-conductor insulating member 34 is formed of a material having an electrical insulation property. Furthermore, inter-conductor insulating member 34 may be bonded to multilayer insulating member 32 by an adhesive member such as a pressure-sensitive adhesive or an adhesive. For example, inter-conductor insulating member 34 may be formed of a material containing any of glass fiber reinforced epoxy resin, phenol resin, polyphenylene sulfide (PPS), and polyether ether ketone. Alternatively, inter-conductor insulating member 34 may be formed of a material containing any of polyethylene terephthalate (PET), polyimide (PI), and an aramid (wholly aromatic polyamide) fiber.

Alternatively, inter-conductor insulating member 34 may be made of a ceramic material such as aluminum oxide (Al₂O₃) or aluminum nitride (AlN). Furthermore, when high rigidity is not required, inter-conductor insulating member 34 may be formed of a silicone rubber sheet or a urethane rubber sheet. Alternatively, inter-conductor insulating member 34 may be formed of silicone gel, silicone grease, or a silicone adhesive. Inter-conductor insulating member 34 may have a sheet shape or a film shape.

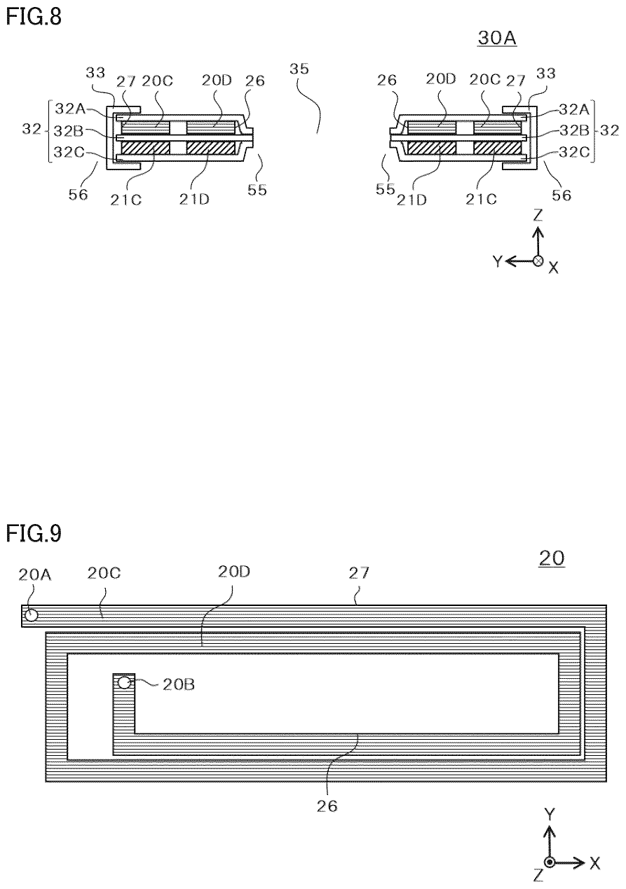

Laminate coil 30 in which first coil 20, second coil 21, and third coil 22 are laminated has been described as an example in which the number of laminated coils is an odd number. However, the number of laminated coils may be an even number. FIG. 8 illustrates a laminate coil 30A in which first coil 20 and second coil 21 are laminated as an example in which the number of laminated coils is the even number. Laminate coil 30A has the multilayer structure in which first multilayer insulating member 32A, first coil 20, second multilayer insulating member 32B, second coil 21, and third multilayer insulating member 32C are laminated in this order in the Z-direction.

When the number of laminated coils is the even number, the number of multilayer insulating members 32 is the odd number. For this reason, at inner end 55 of laminate coil 30A, for example, first multilayer insulating member 32A and third multilayer insulating member 32C are bonded to each other such that other multilayer insulating members 32 are gathered to second multilayer insulating member 32B located at the center in the Z-direction that is the multilayer direction of the coil. In addition, multilayer insulating member 32 located at the center of the coil in the Z-direction is bonded without being bent at the corner of inside end 26 of first coil 20 or second coil 21. Here, the description of coil device 101A including laminate coil 30A is omitted.

Multilayer insulating member 32 included in laminate coil 30 or laminate coil 30A is formed of a material having an electrical insulation property. For example, multilayer insulating member 32 is formed of a material containing either polyethylene terephthalate (PET) or polyimide (PI), or an aramid (wholly aromatic polyamide) fiber. Alternatively, multilayer insulating member 32 may be formed of a material containing any of a glass fiber-reinforced epoxy resin, a phenol resin, polyphenylene sulfide (PPS), and polyether ether ketone. Furthermore, multilayer insulating member 32 may be formed of a ceramic material such as aluminum oxide (Al₂O₃) or aluminum nitride (AlN).

Furthermore, as another feature, multilayer insulating member 32 has an adhesive member such as a pressure-sensitive adhesive or an adhesive on an arbitrary surface. The plurality of multilayer insulating members 32 adjacent to each other are bonded by the adhesive member. In addition, multilayer insulating member 32 may be bonded to first coil 20, second coil 21, and third coil 22. Specifically, in the plurality of multilayer insulating members 32, an adhesive member is applied to at least each of surfaces facing the first coil, the second coil, and the third coil. For example, a heat-curable adhesive member that is cured by applying heat may be used as the adhesive member. Here, an epoxy-based material, a silicone-based material, or an acrylic material is used as the adhesive member.

With reference to FIGS. 9 to 11, first coil 20, second coil 21, and third coil 22 included in laminate coil 30 will be described below. For example, each of first coil 20, second coil 21, and third coil 22 is made of a flat conductor formed by punching the flat conductor, and has a shape in which the flat conductor is wound. Furthermore, the flat plate has a generally rectangular flat plate shape which expands along the XY-plane, and includes a plurality of linear portions and a plurality of corner portions. However, the shape is not limited to the rectangle, and for example, may be an elliptical shape extending on the XY-plane or a circular flat plate shape. The number of windings may be one or a plurality of windings. In the present disclosure, the case where the number of windings is the plurality of windings will be described. Here, a thickness of the flat conductor of each of first coil 20, second coil 21, and third coil 22 may be the same or different. In other words, laminate coil 30 may include a first thick coil formed from the flat conductor having a first thickness and a second thick coil formed from the flat conductor having a second thickness. Here, the thickness of the flat conductor is the thickness of the flat conductor in the Z-direction that is a direction perpendicular to the XY-plane.

Widths of the flat conductors of first coil 20, second coil 21, and third coil 22 may be the same or different. In other words, laminate coil 30 may include a first-width coil formed of the flat conductor having a first width and a second-width coil formed of the flat conductor having a second width. Here, the width of the flat conductor is a width of the flat conductor in a direction perpendicular to the winding direction on the XY-plane.

FIG. 9 is a schematic plan view illustrating first coil 20 included in laminate coil 30 in planar view from the Z-direction. In planar view, first coil 20 includes a connection portion 20A provided to be connectable to inverter circuit 2 at one end in the winding direction of first coil 20 in an outer peripheral portion of first coil 20. In planar view, first coil 20 also includes a connection portion 20B that is provided so as to be connectable to inverter circuit 2 at the other end in the winding direction of first coil 20 in an inner peripheral portion of first coil 20. First coil 20 is wound twice clockwise so as to form an opening on the inner side from connection portion 20A that is one end to connection portion 20B that is the other end. Here, the flat conductor of the outer peripheral portion is referred to as first turn 20C, and the flat conductor of the inner portion is referred to as second turn 20D. For example, connection portion 20A and connection portion 20B are holes made in the flat conductor.

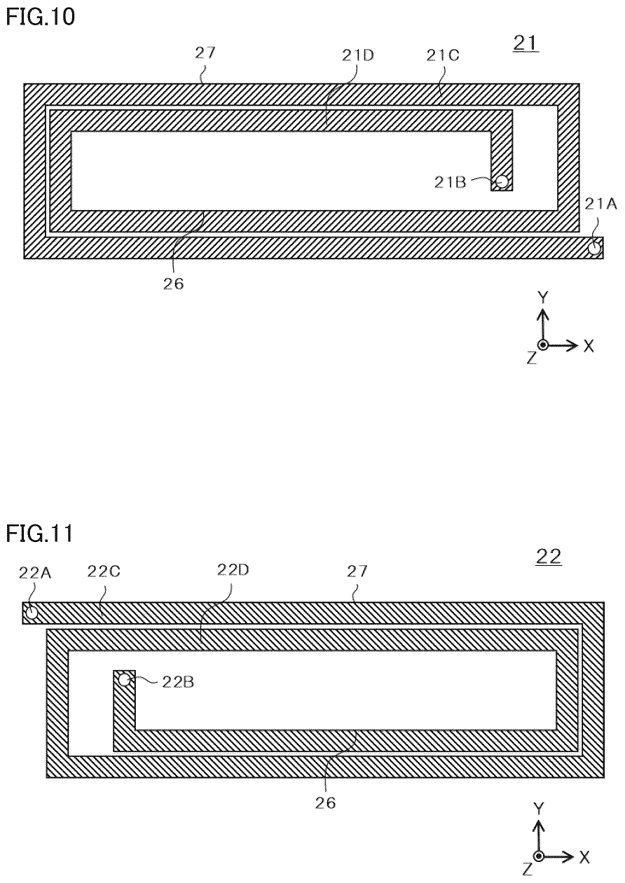

FIG. 10 is a schematic plan view illustrating second coil 21 included in laminate coil 30 in planar view from the Z-direction. In planar view, second coil 21 includes a connection portion 21A provided to be connectable to rectifier circuit 4 at one end in the winding direction of second coil 21 in the outer peripheral portion of second coil 21. In planar view, second coil 21 includes a connection portion 21B provided to be connectable to rectifier circuit 4 at the other end in the winding direction of second coil 21 in the inner peripheral portion of second coil 21. Second coil 21 is wound twice clockwise so as to form an opening on the inner side from connection portion 21A that is one end to connection portion 21B that is the other end. Here, the flat conductor of the outer peripheral portion is referred to as first turn 21C, and the flat conductor of the inner portion is referred to as second turn 21D. For example, connection portion 21A and connection portion 21B are holes made in the flat conductor.

FIG. 11 is a schematic plan view illustrating third coil 22 included in laminate coil 30 in planar view from the Z-direction. In planar view, third coil 22 includes a connection portion 22A provided to be connectable to inverter circuit 2 at one end in the winding direction of third coil 22 in the outer peripheral portion of third coil 22. In planar view, third coil 22 also includes a connection portion 22B that is provided so as to be connectable to inverter circuit 2 at the other end in the winding direction of third coil 22 in the inner peripheral portion of third coil 22. Third coil 22 is wound twice clockwise so as to form an opening on the inner side from connection portion 22A that is one end to connection portion 22B that is the other end. Here, the flat conductor of the outer peripheral portion is referred to as first turn 22C, and the flat conductor of the inner peripheral portion is referred to as second turn 22D. For example, connection portion 22A and connection portion 22B are holes made in the flat conductor.

As illustrated in FIGS. 1 and 2, in power conversion device 1, connection portion 20A of first coil 20 and connection portion 22A of third coil 22 are connected to connection terminal 23A. Connection portion 20B of first coil 20 and connection portion 22B of third coil 22 are connected to connection terminal 23B. Thus, first coil 20 and third coil 22, which are the primary-side coils, are connected in parallel to inverter circuit 2. Furthermore, connection portion 21A of second coil 21 is connected to connection terminal 24A. Connection portion 21B of second coil 21 is connected to connection terminal 24B. Thus, second coil 21 that is the secondary-side coil is connected to rectifier circuit 4.

At this point, first coil 20, second coil 21, and third coil 22 that are included in laminate coil 30 are formed using the flat conductor. For example, the thickness of the flat conductor in the Z-direction is greater than or equal to 0.1 mm and less than or equal to 5.0 mm. In addition, the thickness of the flat conductor in the Z-direction is more preferably greater than or equal to 0.5 mm and less than or equal to 2.0 mm. The thickness of the flat conductor used for each of first coil 20, second coil 21, and third coil 22 may be changed according to a flowing current. The width of the flat conductor of each of first coil 20, second coil 21, and third coil 22 may be changed according to the number of turns of the coil or an amount of current flowing. Here, for example, the flat conductor is formed of a material containing copper or aluminum.

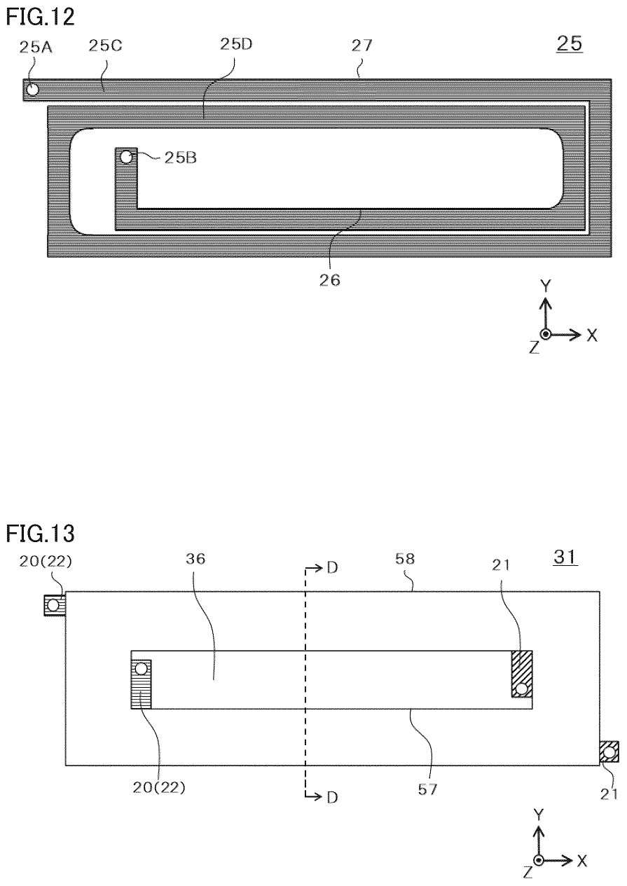

Furthermore, for example, a deformation coil 25 in FIG. 12 may be used instead of first coil 20. Deformation coil 25 is different from first coil 20 in that an inner corner portion of the flat conductor at inside end 26 on the through-hole side is rounded in planar view from the Z-direction, and for example, is arc-shaped. Here, as an example, the description in which first coil 20 is replaced with deformation coil 25 has been given, but the same coil as deformation coil 25 may be used in second coil 21 and third coil 22. Thus, the plurality of multilayer insulating members 32 can be bonded to each other without breakage or gap at the inner corner portion of the flat conductor at inside end 26 of the coil.

Effects of laminate coil 30 and coil device 101 of the first embodiment will be described below. Laminate coil 30 has a multilayer structure in which first multilayer insulating member 32A, first coil 20, second multilayer insulating member 32B, second coil 21, third multilayer insulating member 32C, third coil 22, and fourth multilayer insulating member 32D are laminated in this order in the Z-direction that is the multilayer direction. In other words, laminate coil 30 has the multilayer structure in which each of first coil 20, second coil 21, and third coil 22 is disposed so as to be sandwiched between the plurality of multilayer insulating members 32 and is laminated in the Z-direction.

In inner end 55 of laminate coil 30 in planar view, the plurality of multilayer insulating members 32 adjacent to each other in the Z-direction are bonded to each other. That is, inside end 26 of each of first coil 20, second coil 21, and third coil 22 in planar view is shut tightly by the plurality of multilayer insulating members 32. In other words, inside end 26 of each of first coil 20, second coil 21, and third coil 22 is sealed by the plurality of multilayer insulating members 32. Thus, the coil can be prevented from exposing from between multilayer insulating members 32 by positional displacement of the coil due to vibration, expansion or contraction of the coil due to heat, or deformation of the coil.

Thus, coil device 101 including laminate coil 30 of the first embodiment can prevent degradation of a characteristic of coil device 101 due to the short circuit between the coil and the core.

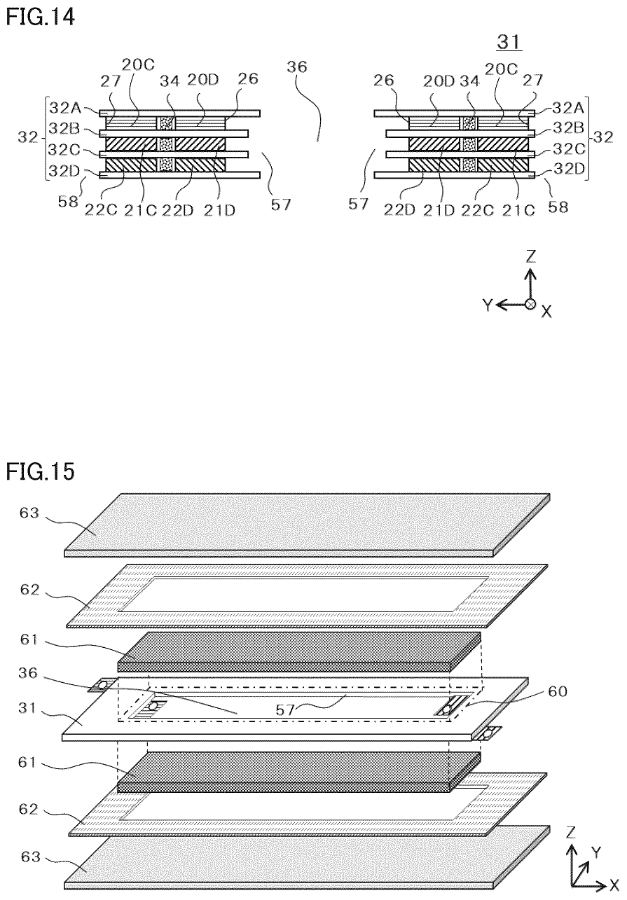

With reference to FIGS. 13 to 17, a method for manufacturing laminate coil 30 of the first embodiment will be described below. The method for manufacturing laminate coil 30 includes first to fourth steps. FIGS. 13 and 14 illustrate the first step of the method for manufacturing laminate coil 30 of the first embodiment.

FIG. 13 is a schematic plan view illustrating a multilayer body 31 in which first multilayer insulating member 32A, first coil 20, second multilayer insulating member 32B, second coil 21, third multilayer insulating member 32C, third coil 22, and fourth multilayer insulating member 32D are laminated in this order in the Z-direction. In other words, FIG. 13 is the schematic plan view illustrating multilayer body 31 in which each of first coil 20, second coil 21, and third coil 22 is disposed so as to be sandwiched between each of the plurality of multilayer insulating members 32 and are laminated and formed in the Z-direction. In addition, multilayer body 31 has a shape including a through-hole 36 penetrating the plurality of coils and the plurality of multilayer insulating members 32 in the Z-direction that is the multilayer direction inside the coil in planar view from the Z-direction.

FIG. 14 is a schematic sectional view illustrating multilayer body 31 taken along a line D-D in FIG. 13. As illustrated in FIGS. 13 and 14, each of first coil 20, second coil 21, and third coil 22 is disposed so as to be sandwiched between two multilayer insulating members 32 adjacent to each other in the Z-direction. Specifically, each of first coil 20, second coil 21, and third coil 22 is disposed in a region where two multilayer insulating members 32 adjacent in the Z-direction are opposite to each other except for the connection portion. In other words, each of first coil 20, second coil 21, and third coil 22 is disposed inside two multilayer insulating members 32 adjacent in the Z-direction in planar view except for the connection portion.

In addition, each of multilayer insulating members 32 protrudes from inside end 26 of first coil 20, second coil 21, and third coil 22 to through-hole 36 at an inner end 57 of multilayer body 31. Furthermore, a protruding length from inside end 26 of first coil 20 and third coil 22 to through-hole 36 of each of first multilayer insulating member 32A and fourth multilayer insulating member 32D provided at both ends in the Z-direction that is the multilayer direction of multilayer body 31 is provided to be longer than a protruding length from inside end 26 of second coil 21 to through-hole 36 of each of second multilayer insulating member 32B and third multilayer insulating member 32C other than first multilayer insulating member 32A and fourth multilayer insulating member 32D. At this point, inner end 57 of multilayer body 31 is an end positioned on the side of through-hole 36 in multilayer body 31 in planar view.

Furthermore, the protruding length from inside end 26 of first coil 20, second coil 21, and third coil 22 to through-hole 36 in each multilayer insulating member 32 is provided to be larger than the protruding length from outside end 27 of first coil 20, second coil 21, and third coil 22 to the outside that is the direction opposite to through-hole 36 in each multilayer insulating member 32.

In the first embodiment, the protruding length is changed by changing the width of each multilayer insulating member 32. Specifically, in multilayer body 31, the widths of first multilayer insulating member 32A and fourth multilayer insulating member 32D provided at both ends in the Z-direction that is the multilayer direction of multilayer body 31 are larger than the widths of second multilayer insulating member 32B and third multilayer insulating member 32C other than first multilayer insulating member 32A and fourth multilayer insulating member 32D. At this point, the width of multilayer insulating member 32 is a width along a direction perpendicular to the winding direction of the flat conductor of each coil on the XY-plane.

With reference to FIGS. 15 to 17, the second to fourth steps in the method for manufacturing laminate coil 30 of the first embodiment will be described below. FIG. 15 is a schematic perspective view illustrating the second step of the method for manufacturing laminate coil 30 of the first embodiment. A pair of pressing elastic members 61, a pair of frame plates 62, and a pair of pressing members 63 are disposed so as to sandwich multilayer body 31 in the Z-direction that is the multilayer direction. Specifically, the pair of pressing elastic members 61, which is the pair of first pressing elastic members, is disposed so as to sandwich a pressing region 60 surrounded by a dotted broken line of multilayer body 31 in the Z-direction of multilayer body 31. Pressing region 60 is located at least on the side of through-hole 36 of multilayer body 31 in planar view, and includes inner end 57 that is a part of multilayer body 31. Furthermore, pressing region 60 includes a part of through-hole 36. At this point, pressing region 60 may include the entire region of through-hole 36.

Subsequently, the pair of frame plates 62 is disposed so as to sandwich multilayer body 31 in the Z-direction. An opening larger than pressing elastic member 61 is provided in frame plates 62. Thus, frame plate 62 and pressing elastic member 61 do not overlap each other in planar view. In other words, in planar view, frame plate 62 is disposed so as to surround pressing elastic member 61. Furthermore, the pair of pressing members 63 is prepared so as to sandwich pressing elastic member 61 and frame plate 62 in the Z-direction.

The third step of the method for manufacturing laminate coil 30 of the first embodiment will be described below. In the third step, pressure is applied between the pair of pressing members 63 using a pressing machine or the like. Thus, frame plate 62 and pressing elastic member 61 are pressed in the Z-direction that is the multilayer direction. Thus, the pressure required for forming laminate coil 30 is applied to multilayer body 31.

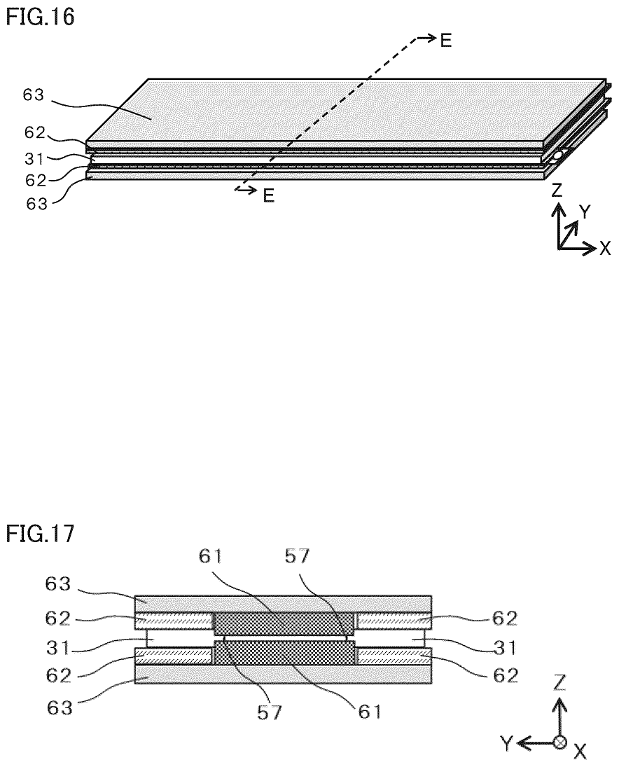

FIG. 16 is a schematic perspective view illustrating the state in which the pressure required for forming laminate coil 30 is applied to multilayer body 31 using pressing elastic member 61, frame plate 62, and pressing member 63 in the Z-direction of the multilayer body. FIG. 17 is a schematic sectional view taken along a sectional line E-E in FIG. 16. As illustrated in FIG. 17, the pair of pressing elastic members 61 sandwiches inner end 57 that is a part of multilayer body 31 by applying the pressure between the pair of pressing members 63, and applies the pressure in the Z-direction. The pair of frame plates 62 sandwiches a part of a region other than the inner end of multilayer body 31, and applies the pressure in the Z-direction.

The fourth step of the method for manufacturing laminate coil 30 of the first embodiment will be described below. In the fourth step, multilayer body 31 is heated from 70° C. to 150° C. while the pressure is applied to multilayer body 31 in FIGS. 16 and 17. The adhesive member applied to each of multilayer insulating members 32 is cured by this heating. Thus, at inner end 57 of multilayer body 31, the plurality of multilayer insulating members 32 that protrude to through-hole 36 and are adjacent in the Z-direction are bonded to each other. Specifically, first multilayer insulating member 32A and second multilayer insulating member 32B are bonded to each other at inner end 55 of laminate coil 30. Second multilayer insulating member 32B and third multilayer insulating member 32C are bonded to each other. Third multilayer insulating member 32C and fourth multilayer insulating member 32D are bonded to each other.

At this point, the third step and the fourth step in the method for manufacturing laminate coil 30 of the first embodiment may be simultaneously performed. Specifically, for example, multilayer body 31 is sandwiched between the pair of pressing members 63, the pair of frame plates 62, and the pair of pressing elastic members 61 that are heated, and the pressure is applied to multilayer body 31 in the Z-direction. In this manner, the pressure and heat required for forming laminate coil 30 are applied to multilayer body 31. Thus, at inner end 57 of multilayer body 31, the plurality of multilayer insulating members 32 that protrude to through-hole 36 and are adjacent in the Z-direction can be bonded to each other.

Thus, inside end 26 of each of first coil 20, second coil 21, and third coil 22 is sealed by the plurality of multilayer insulating members 32. In addition, each of the plurality of multilayer insulating members 32 can be bonded to each of first coil 20, second coil 21, and third coil 22. Furthermore, inter-conductor insulating member 34 can also adhere to multilayer insulating member 32.

At outer end 58 of multilayer body 31 in planar view, outside ends 27 of first coil 20, second coil 21, and third coil 22 are covered with insulating sealing member 33 such as an insulating tape so as not to be exposed. Outside ends 27 of first coil 20, second coil 21, and third coil 22 may be sealed by insulating sealing member 33. At this point, insulating sealing member 33 is not limited to the insulating tape. Thus, laminate coil 30 is formed.

For example, pressing elastic member 61 used in the method for manufacturing laminate coil 30 of the first embodiment is formed using foamed silicone, foamed urethane, or silicone rubber. As described above, multilayer insulating member 32 can be prevented from being damaged using pressing elastic member 61 at inner end 57 of multilayer body 31. Furthermore, because pressing elastic member 61 is deformed following the shape of multilayer body 31, multilayer insulating members 32 can be bonded to each other without breakage or gap even at a step portion of the coil or the inner corner portion of the flat conductor. In addition, even when the number of laminated coils is changed, the width of the flat conductor is changed, and when the thickness of the flat conductor is changed, multilayer insulating members 32 can be bonded to each other without any damage or gap.

Pressing member 63 is made of a material having high thermal conductivity, such as aluminum or a metal containing iron. Thus, the heat required for curing the adhesive member can be efficiently applied to multilayer body 31. Frame plate 62 is made of a material having high thermal conductivity, such as aluminum or a metal containing iron. Thus, the heat required for curing the adhesive member can be efficiently applied to multilayer body 31. In addition, the pair of frame plates 62 applies the pressure to multilayer body 31 in the Z-direction that is the multilayer direction, so that displacement of the coil can be prevented.

As described above, even in inner end 57 of multilayer body 31 that is difficult to seal without breakage or gaps due to a shape characteristic such as many curved portions, each of the plurality of multilayer insulating members 32 can be bonded without breakage or gaps using the method for manufacturing laminate coil 30 of the first embodiment. Accordingly, inside ends 26 of first coil 20, second coil 21, and third coil 22 can be shut tightly. In other words, inside ends 26 of first coil 20, second coil 21, and third coil 22 can be sealed by the plurality of multilayer insulating members 32. Furthermore, the characteristic degradation of coil device 101 due to the short circuit between the coil and the core can be prevented when laminate coil 30 of the first embodiment is used for coil device 101.

### First Modification of First Embodiment

A laminate coil 30B according to a first modification of the first embodiment and a coil device 101B including laminate coil 30B of the first modification of the first embodiment will be described below. In the first modification of the first embodiment, only portions in the configuration different from the first embodiment will be described. In addition, the same reference numerals are used for the same or corresponding configurations as those in the first embodiment, and the description thereof will be omitted. Here, coil device 101B is not illustrated.

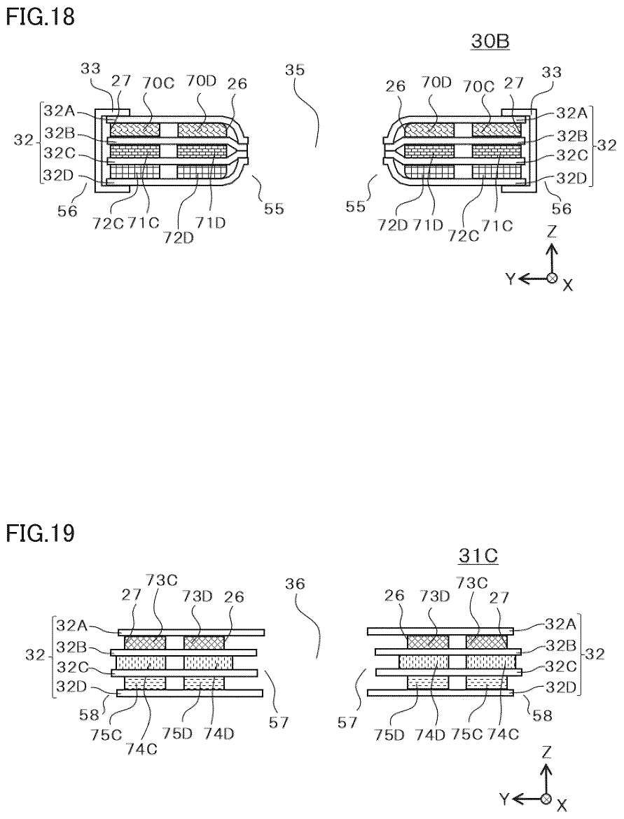

FIG. 18 is a schematic sectional view illustrating laminate coil 30B of the first modification of the first embodiment. In laminate coil 30B, first multilayer insulating member 32A, a fifth coil 70, second multilayer insulating member 32B, a sixth coil 71, third multilayer insulating member 32C, a seventh coil 72, and fourth multilayer insulating member 32D are laminated in this order in the Z-direction that is the multilayer direction. In other words, laminate coil 30B is disposed such that each of fifth coil 70, sixth coil 71, and seventh coil 72 is sandwiched between the plurality of multilayer insulating members 32, and is laminated in the Z-direction.

At inner end 55 of laminate coil 30B, the plurality of multilayer insulating members 32 adjacent to each other are bonded to each other. Thus, inside end 26 of each of fifth coil 70, sixth coil 71, and seventh coil 72 is shut tightly by the plurality of multilayer insulating members 32. In other words, inside end 26 of each of fifth coil 70, sixth coil 71, and seventh coil 72 is sealed by the plurality of multilayer insulating members 32.

Here, inner end 55 of laminate coil 30B is an end of laminate coil 30B located on the through-hole 35 side in planar view. Inside end 26 of each of fifth coil 70, sixth coil 71, and seventh coil 72 is an end located on the through-hole 35 side in each of first coil 20, second coil 21, and third coil 22 in planar view.

In outer end 56 of laminate coil 30B, outside ends 27 of fifth coil 70, sixth coil 71, and seventh coil 72 are covered with insulating sealing member 33 such as the insulating tape so as not to be exposed. Outside ends 27 of fifth coil 70, sixth coil 71, and seventh coil 72 may be sealed by insulating sealing member 33. Insulating sealing member 33 is not limited to the insulating tape.

Here, outer end 56 of laminate coil 30B is an end located in the direction opposite to inner end 55 on the through-hole 35 side in laminate coil 30B in planar view. Outside ends 27 of fifth coil 70, sixth coil 71, and seventh coil 72 are ends located in the direction opposite to inside end 26 that is on the through-hole 35 side in fifth coil 70, sixth coil 71, and seventh coil 72 in planar view.

As illustrated in FIG. 18, in laminate coil 30B of the first modification of the first embodiment, in fifth coil 70 and seventh coil 72 disposed at both ends in the Z-direction that is the multilayer direction, at least inside ends 26 and at least outside corners in the Z-direction are chamfered and rounded. Accordingly, when multilayer insulating members 32 are bonded to each other, the breakage of multilayer insulating member 32 can be prevented at inner end 55 of laminate coil 30B.

As described above, in inner end 55 of laminate coil 30B of the first modification of the first embodiment, multilayer insulating members 32 are bonded to each other without breakage or gap. That is, inside end 26 of each of fifth coil 70, sixth coil 71, and seventh coil 72 is shut tightly. In other words, inside end 26 of each of fifth coil 70, sixth coil 71, and seventh coil 72 is sealed by the plurality of multilayer insulating members 32. Thus, coil device 101B including laminate coil 30B of the first modification of the first embodiment can prevent the degradation of the characteristic due to the short circuit between the coil and the core.

### Second Modification of First Embodiment

A laminate coil 30C according to a second modification of the first embodiment and a coil device 101C including laminate coil 30C of the second modification of the first embodiment will be described below. In the second modification of the first embodiment, only portions in the configuration different from the first embodiment will be described. In addition, the same reference numerals are used for the same or corresponding configurations as those in the first embodiment, and the description thereof will be omitted. Here, coil device 101C is not illustrated.

FIG. 19 is a schematic sectional view illustrating a configuration of a multilayer body 31C of the second modification of the first embodiment. First multilayer insulating member 32A, an eighth coil 73, second multilayer insulating member 32B, a ninth coil 74, third multilayer insulating member 32C, a tenth coil 75, and fourth multilayer insulating member 32D are laminated in this order in the Z-direction. In other words, each of eighth coil 73, ninth coil 74, and tenth coil 75 is disposed so as to be sandwiched between the plurality of multilayer insulating members 32, and is laminated in the Z-direction.

As illustrated in FIG. 19, at inner end 57 of multilayer body 31C, each of multilayer insulating members 32 protrudes from inside end 26 of each of eighth coil 73, ninth coil 74, and tenth coil 75 to through-hole 36. At this point, in the Z-direction that is the multilayer direction of multilayer body 31C, the protruding length from inside end 26 of eighth coil 73 and tenth coil 75 to through-hole 36 in each of first multilayer insulating member 32A and fourth multilayer insulating member 32D provided at both ends is provided to be longer than the protruding length from inside end 26 of ninth coil 74 to through-hole 36 in each of other than second multilayer insulating member 32B and third multilayer insulating member 32C.

At this point, inner end 57 of multilayer body 31C is an end positioned on the side of through-hole 36 in multilayer body 31C in planar view. Inside end 26 of each of eighth coil 73, ninth coil 74, and tenth coil 75 is an end located on the side of through-hole 36 in each of eighth coil 73, ninth coil 74, and tenth coil 75 in planar view.

In the second modification of the first embodiment, the protruding length of multilayer insulating member 32 is changed by changing the width of the flat conductor of each of eighth coil 73, ninth coil 74, and tenth coil 75. Specifically, for example, in multilayer body 31C, the width of the flat conductor of each of eighth coil 73 and tenth coil 75 provided at both ends in the Z-direction that is the multilayer direction of multilayer body 31 is smaller than the width of the flat conductor of ninth coil 74. Here, the width of the flat conductor of the coil is the width of the flat conductor in the direction perpendicular to the winding direction of the coil on the XY-plane.

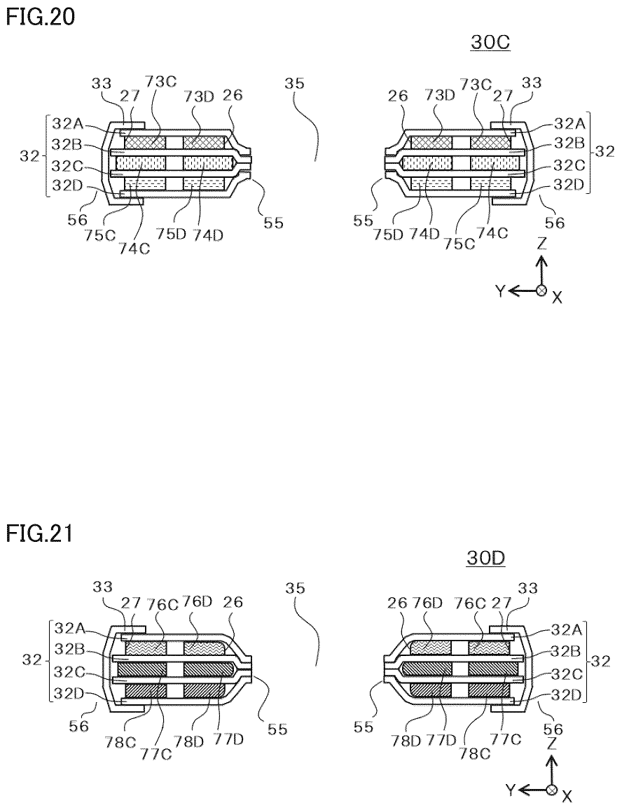

FIG. 20 is a schematic sectional view of laminate coil 30C. In laminate coil 30C, first multilayer insulating member 32A, eighth coil 73, second multilayer insulating member 32B, ninth coil 74, third multilayer insulating member 32C, tenth coil 75, and fourth multilayer insulating member 32D are laminated in this order in the Z-direction. In other words, laminate coil 30C is disposed such that each of eighth coil 73, ninth coil 74, and tenth coil 75 is sandwiched between the plurality of multilayer insulating members 32, and is laminated in the Z-direction.

In inner end 55 of laminate coil 30C, the plurality of multilayer insulating members 32 adjacent to each other in the Z-direction are bonded to each other. Thus, inside end 26 of each of eighth coil 73, ninth coil 74, and tenth coil 75 is shut tightly by the plurality of multilayer insulating members 32. In other words, inside end 26 of each of eighth coil 73, ninth coil 74, and tenth coil 75 is sealed by the plurality of multilayer insulating members 32.

In outer end 56 of laminate coil 30C, outside ends 27 of eighth coil 73, ninth coil 74, and tenth coil 75 are covered with insulating sealing member 33 such as the insulating tape so as not to be exposed. Outside ends 27 of eighth coil 73, ninth coil 74, and 10 coil 75 may be sealed by insulating sealing member 33. Insulating sealing member 33 is not limited to the insulating tape.

Here, outer end 56 of laminate coil 30C is an end located in the direction opposite to inner end 55 on the through-hole 35 side in laminate coil 30C in planar view. Outside ends 27 of eighth coil 73, ninth coil 74, and tenth coil 75 are ends located in the direction opposite to inside end 26 on the through-hole 35 side in eighth coil 73, ninth coil 74, and tenth coil 75 in planar view.

In laminate coil 30C of the second modification of the first embodiment, as illustrated in FIG. 20, the width of the flat conductor of each of eighth coil 73 and tenth coil 75 disposed at both ends in the Z-direction is smaller than the width of the flat conductor of ninth coil 74 disposed in a central portion except for both ends. In other words, in the Z-direction, the width of the flat conductor of ninth coil 74 disposed in the central portion except for both ends is larger than the width of the flat conductor of each of eighth coil 73 and tenth coil 75 at both ends. Here, the width of the flat conductor is the width of the flat conductor in the direction perpendicular to the winding direction of the coil on the XY-plane.

Accordingly, when multilayer insulating members 32 are bonded to each other, the breakage of multilayer insulating member 32 can be prevented at inner end 55 of laminate coil 30C. Here, the case where the number of laminated coils is three has been described as an example, but the number of laminated coils may be smaller or larger than three. When the number of laminated coils is more than three, the number of coils disposed in the central portion except both ends is a plurality of layers. In addition, the widths of the flat conductors of the plurality of layers of coils disposed in the central portion may be different from each other.

As described above, in inner end 55 of laminate coil 30C of the second modification of the first embodiment, the plurality of multilayer insulating members 32 can be bonded to each other without any damage or gap. Inside end 26 of each of eighth coil 73, ninth coil 74, and tenth coil 75 can be shut tightly. In other words, inside end 26 of each of eighth coil 73, ninth coil 74, and tenth coil 75 can be sealed by the plurality of multilayer insulating members 32. Thus, coil device 101C including laminate coil 30C of the second modification of the first embodiment can prevent the degradation of the characteristic due to the short circuit between the coil and the core.

### Third Modification of First Embodiment

A laminate coil 30D according to a third modification of the first embodiment and a coil device 101D including laminate coil 30D of the third modification of the first embodiment and will be described below. In the third modification of the first embodiment, only portions in the configuration different from the first embodiment will be described. In addition, the same reference numerals are used for the same or corresponding configurations as those in the first embodiment, and the description thereof will be omitted. Here, coil device 101D is not illustrated.

FIG. 21 is a schematic sectional view illustrating laminate coil 30D of the third modification of the first embodiment. In laminate coil 30D, first multilayer insulating member 32A, an eleventh coil 76, second multilayer insulating member 32B, a twelfth coil 77, third multilayer insulating member 32C, a thirteenth coil 78, and fourth multilayer insulating member 32D are laminated in this order in the Z-direction that is the multilayer direction. In other words, laminate coil 30D is disposed such that each of eleventh coil 76, twelfth coil 77, and thirteenth coil 78 is sandwiched between the plurality of multilayer insulating members 32, and is laminated in the Z-direction.

At inner end 55 of laminate coil 30D, the plurality of multilayer insulating members 32 adjacent to each other are bonded to each other. Thus, inside end 26 of each of eleventh coil 76, twelfth coil 77, and thirteenth coil 78 is shut tightly by the plurality of multilayer insulating members 32. In other words, inside end 26 of each of eleventh coil 76, twelfth coil 77, and thirteenth coil 78 is sealed by the plurality of multilayer insulating members 32.

Here, inner end 55 of laminate coil 30D is an end of laminate coil 30D located on the through-hole 35 side in planar view. Inside end 26 of each of eleventh coil 76, twelfth coil 77, and thirteenth coil 78 is an end located on the through-hole 35 side in each of eleventh coil 76, twelfth coil 77, and thirteenth coil 78 in planar view.

In outer end 56 of laminate coil 30D, outside ends 27 of eleventh coil 76, twelfth coil 77, and thirteenth coil 78 are covered with insulating sealing member 33 such as the insulating tape so as not to be exposed. Outer ends 27 of eleventh coil 76, twelfth coil 77, and thirteenth coil 78 may be sealed by insulating sealing member 33. Insulating sealing member 33 is not limited to the insulating tape.

Here, outer end 56 of laminate coil 30D is an end located in the direction opposite to inner end 55 on the through-hole 35 side in laminate coil 30D in planar view. Outer ends 27 of eleventh coil 76, twelfth coil 77, and thirteenth coil 78 are ends located in the direction opposite to inside end 26 on the through-hole 35 side in eleventh coil 76, twelfth coil 77, and thirteenth coil 78 in planar view.

In laminate coil 30D of the third modification of the first embodiment, as illustrated in FIG. 21, in the Z-direction that is the multilayer direction, the width of the flat conductor of twelfth coil 77 disposed at the center portion except for both ends is larger than the width of the flat conductor of each of eleventh coil 76 and thirteenth coil 78 at both ends. In other words, the width of the flat conductor of each of eleventh coil 76 and thirteenth coil 78 disposed at both ends in the Z-direction is smaller than the width of the flat conductor of twelfth coil 77 disposed at the central portion except for both ends. Here, the width of the flat conductor is the width of the flat conductor in the direction perpendicular to the winding direction of the coil on the XY-plane.

In laminate coil 30D of the third modification of the first embodiment, as illustrated in FIG. 21, in eleventh coil 76 and thirteenth coil 78 disposed at both ends in the Z-direction that is the multilayer direction, at least the inside end and at least the outside corner in the Z-direction are chamfered and rounded. Furthermore, in twelfth coil 77 disposed in the central portion except for both ends in the Z-direction, at least the corner of the inside end may be chamfered and rounded. Accordingly, when the plurality of multilayer insulating members 32 are bonded to each other, the breakage of multilayer insulating member 32 can be prevented at the inner end of laminate coil 30D.

Thus, in inner end 55 of laminate coil 30D of the third modification of the first embodiment, the plurality of multilayer insulating members 32 can be bonded to each other without any damage or gap. Here, the case where the number of laminated coils is three has been described as an example, but the number of laminated coils may be smaller or larger than three. When the number of laminated coils is more than three, the number of coils disposed in the central portion except both ends is a plurality of layers. In addition, the widths of the flat conductors of the plurality of layers of coils disposed in the central portion may be different from each other.

In this manner, inside end 26 of each of eleventh coil 76, twelfth coil 77, and thirteenth coil 78 can be shut tightly. In other words, inside end 26 of each of eleventh coil 76, twelfth coil 77, and thirteenth coil 78 can be sealed by the plurality of multilayer insulating members 32. Thus, coil device 101D including laminate coil 30D of the third modification of the first embodiment can prevent the degradation of the characteristic due to the short circuit between the coil and the core.

### Second Embodiment

A laminate coil 30E according to a second embodiment and a coil device 101E including laminate coil 30E of the second embodiment will be described below. In the second embodiment, only portions in the configuration different from the first embodiment will be described. In addition, the same reference numerals are used for the same or corresponding configurations as those in the first embodiment, and the description thereof will be omitted.

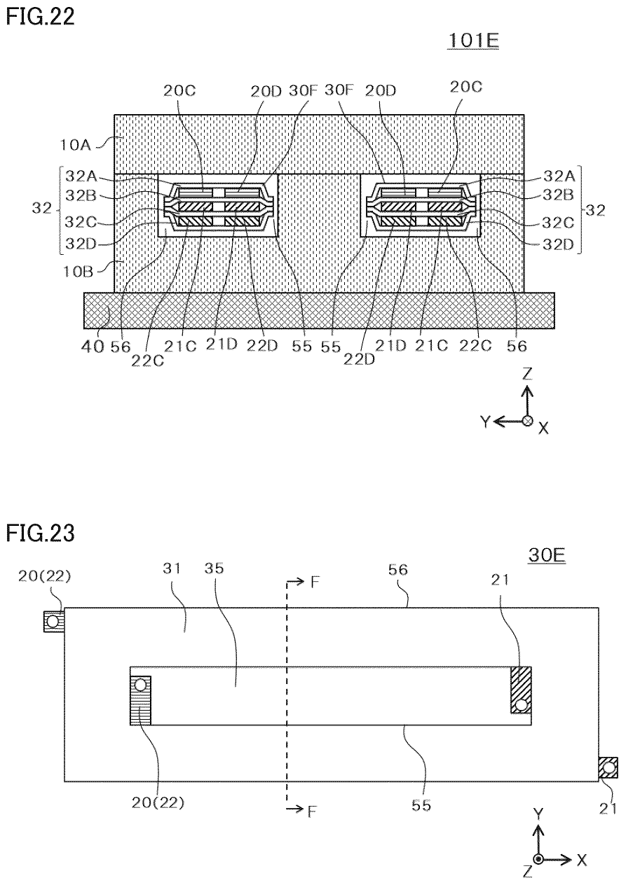

FIG. 22 is a schematic sectional view illustrating coil device 101E of the second embodiment. In coil device 101E of the second embodiment, FIG. 22 illustrates the schematic sectional view illustrating a configuration similar to that of FIG. 5 of the first embodiment. Here, coil device 101E of the second embodiment has the same configuration as coil device 101 of the first embodiment except for laminate coil 30E, and thus the description thereof is omitted.

As illustrated in FIG. 23, laminate coil 30E has a shape having a relatively large surface area in planar view from the Z-direction. In other words, laminate coil 30E spreads along the XY-plane and has a generally rectangular flat shape including a plurality of linear portions and a plurality of corner portions. However, the shape is not limited to the rectangle, and for example, may be an elliptical shape extending on the XY-plane or a circular flat plate shape. Laminate coil 30E has a shape including a through-hole 35 penetrating the plurality of laminated coils and the plurality of multilayer insulating members 32 in the Z-direction that is a multilayer direction inside the coil in planar view.

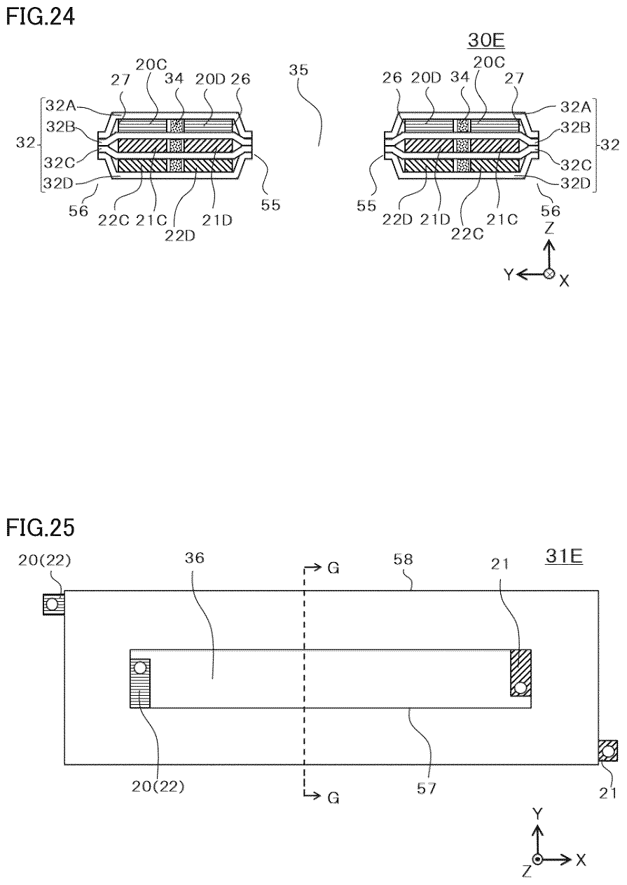

FIG. 24 is a schematic sectional view taken along a sectional line F-F in FIG. 23. As illustrated in FIG. 24, laminate coil 30E has a multilayer structure in which first multilayer insulating member 32A, first coil 20, second multilayer insulating member 32B, second coil 21, third multilayer insulating member 32C, third coil 22, and fourth multilayer insulating member 32D are laminated in this order in the Z-direction. In other words, laminate coil 30E has the multilayer structure in which first coil 20, second coil 21, and third coil 22 are arranged so as to be sandwiched between the plurality of multilayer insulating members 32 and are laminated and formed in the Z-direction.

In planar view, at an inner end 55 of laminate coil 30E, the plurality of multilayer insulating members 32 adjacent to each other in the Z-direction that is the multilayer direction are bonded to each other. Specifically, first multilayer insulating member 32A and second multilayer insulating member 32B are bonded to each other at inner end 55 of laminate coil 30E. Second multilayer insulating member 32B and third multilayer insulating member 32C are bonded to each other. Third multilayer insulating member 32C and fourth multilayer insulating member 32D are bonded to each other. Thus, inside end 26 of each of first coil 20, second coil 21, and third coil 22 is shut tightly by the plurality of multilayer insulating members 32. In other words, inside end 26 of each of first coil 20, second coil 21, and third coil 22 is sealed by the plurality of multilayer insulating members 32.

Furthermore, at outer end 56 of laminate coil 30E in planar view, the plurality of multilayer insulating members 32 adjacent to each other in the Z-direction that is the multilayer direction are bonded to each other. Specifically, first multilayer insulating member 32A and second multilayer insulating member 32B are bonded to each other at outer end 56 of laminate coil 30E. Second multilayer insulating member 32B and third multilayer insulating member 32C are bonded to each other. Third multilayer insulating member 32C and fourth multilayer insulating member 32D are bonded to each other. Thus, outside end 27 of each of first coil 20, second coil 21, and third coil 22 is shut tightly by the plurality of multilayer insulating members 32. In other words, outside end 27 of each of first coil 20, second coil 21, and third coil 22 is sealed by the plurality of multilayer insulating members 32.

Effects of laminate coil 30E and coil device 101F of the second embodiment will be described below. Laminate coil 30E has a multilayer structure in which first multilayer insulating member 32A, first coil 20, second multilayer insulating member 32B, second coil 21, third multilayer insulating member 32C, third coil 22, and fourth multilayer insulating member 32D are laminated in this order in the Z-direction that is the multilayer direction. In other words, laminate coil 30E has the multilayer structure in which each of first coil 20, second coil 21, and third coil 22 is disposed so as to be sandwiched between the plurality of multilayer insulating members 32 and is laminated in the Z-direction.

In inner end 55 of laminate coil 30E in planar view, the plurality of multilayer insulating members 32 adjacent to each other in the Z-direction are bonded to each other. That is, inside end 26 of each of first coil 20, second coil 21, and third coil 22 is shut tightly by the plurality of multilayer insulating members 32. In other words, inside end 26 of each of first coil 20, second coil 21, and third coil 22 is sealed by the plurality of multilayer insulating members 32.

Furthermore, at outer end 56 of laminate coil 30E, the plurality of multilayer insulating members 32 adjacent to each other in the Z-direction are bonded to each other. That is, outside end 27 of each of first coil 20, second coil 21, and third coil 22 is shut tightly by the plurality of multilayer insulating members 32. In other words, outside end 27 of each of first coil 20, second coil 21, and third coil 22 is sealed by the plurality of multilayer insulating members 32. Thus, the coil can be prevented from exposing from between multilayer insulating members 32 by positional displacement of the coil due to vibration, expansion or contraction of the coil due to heat, or deformation of the coil.

Thus, coil device 101E including laminate coil 30E of the second embodiment can prevent degradation of a characteristic of coil device 101E due to the short circuit between the coil and the core.

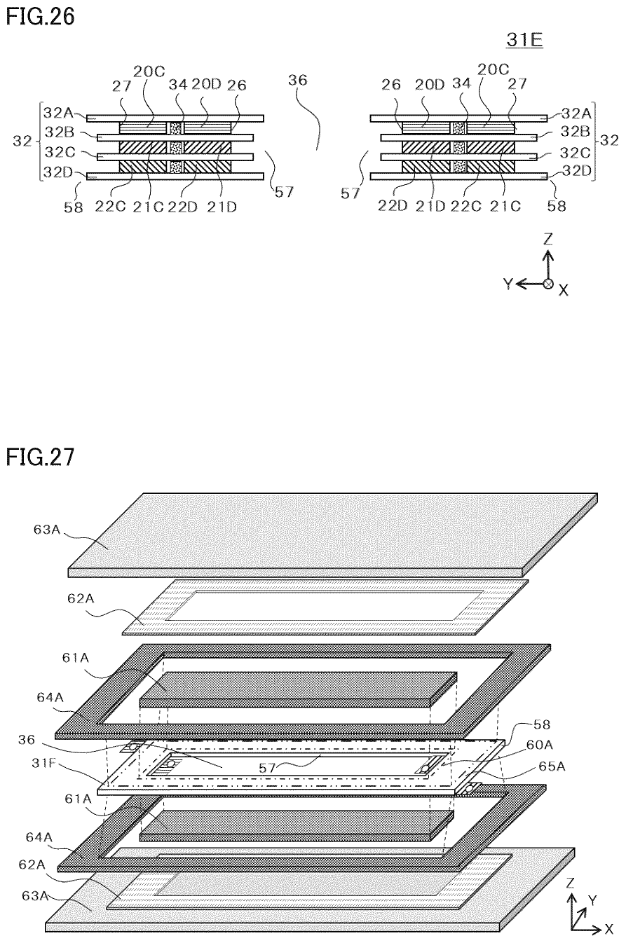

With reference to FIGS. 25 to 29, a method for manufacturing laminate coil 30E of the second embodiment will be described below. The method for manufacturing laminate coil 30E includes first to fourth steps. FIGS. 25 and 26 illustrate the first step of the method for manufacturing laminate coil 30E of the second embodiment.

FIG. 25 is a schematic plan view illustrating a multilayer body 31E in which first multilayer insulating member 32A, first coil 20, second multilayer insulating member 32B, second coil 21, third multilayer insulating member 32C, third coil 22, and fourth multilayer insulating member 32D are laminated in this order in the Z-direction that is the multilayer direction. In other words, FIG. 25 is the schematic plan view illustrating multilayer body 31E in which each of first coil 20, second coil 21, and third coil 22 is disposed so as to be sandwiched between each of the plurality of multilayer insulating members 32 and are laminated and formed in the Z-direction. In addition, multilayer body 31E has a shape including a through-hole 36 penetrating the plurality of coils and the plurality of multilayer insulating members 32 in the Z-direction that is the multilayer direction inside the coil in planar view from the Z-direction.

FIG. 26 is a schematic sectional view illustrating multilayer body 31E taken along line G-G in FIG. 25. As illustrated in FIGS. 25 and 26, each of first coil 20, second coil 21, and third coil 22 is disposed so as to be sandwiched between two multilayer insulating members 32 adjacent to each other in the Z-direction. Specifically, two multilayer insulating members 32 adjacent to each other in the Z-direction are disposed in the opposite regions except for the connection portion. In other words, each of first coil 20, second coil 21, and third coil 22 is disposed inside two multilayer insulating members 32 adjacent in the Z-direction in planar view except for the connection portion.

In addition, each of multilayer insulating members 32 protrudes from inside end 26 of first coil 20, second coil 21, and third coil 22 to through-hole 36 at inner end 57 of multilayer body 31E. Furthermore, the protruding length from inside end 26 of first coil 20 and third coil 22 to through-hole 36 of each of first multilayer insulating member 32A and fourth multilayer insulating member 32D provided at both ends in the Z-direction that is the multilayer direction of multilayer body 31E is provided to be longer than the protruding length from inside end 26 of second coil 21 to through-hole 36 of each of second multilayer insulating member 32B and third multilayer insulating member 32C other than first multilayer insulating member 32A and fourth multilayer insulating member 32D.

Furthermore, each of multilayer insulating members 32 protrudes outward in the direction opposite to through-hole 36 from outside ends 27 of first coil 20, second coil 21, and third coil 22 at outer end 58 of multilayer body 31E. In addition, the protruding length of each of first multilayer insulating member 32A and fourth multilayer insulating member 32D provided at both ends in the Z-direction of multilayer body 31E from outside ends 27 of first coil 20 and third coil 22 to the outside is longer than the protruding length of each of second multilayer insulating member 32B and third multilayer insulating member 32C from outside end 27 of second coil 21 to the outside.

In the second embodiment, the protruding length is changed by changing the width of each of multilayer insulating members 32. Specifically, in multilayer body 31E, the widths of first multilayer insulating member 32A and fourth multilayer insulating member 32D provided at both ends in the Z-direction that is the multilayer direction of multilayer body 31E are larger than the widths of second multilayer insulating member 32B and third multilayer insulating member 32C other than first multilayer insulating member 32A and fourth multilayer insulating member 32D.

With reference to FIGS. 27 to 29, the second to fourth steps in the method for manufacturing laminate coil 30E of the second embodiment will be described below. FIG. 27 is a schematic perspective view illustrating the second step of the method for manufacturing laminate coil 30E. A pair of first pressing elastic members 61A, a pair of second pressing elastic members 64A, a pair of frame plates 62A, and a pair of pressing members 63A are disposed so as to sandwich multilayer body 31E in the Z-direction that is the multilayer direction. Specifically, the pair of first pressing elastic members 61A is disposed so as to sandwich a first pressing region 60A surrounded by a dotted broken line of multilayer body 31E in the Z-direction of multilayer body 31E. First pressing region 60A is located at least on the side of through-hole 36 of multilayer body 31E in planar view, and includes inner end 57 that is a part of multilayer body 31E. In addition, first pressing region 60A includes a part of through-hole 36 of multilayer body 31E. At this point, first pressing region 60A may include the entire region of through-hole 36.

Furthermore, in planar view, a pair of second pressing elastic members 64A is disposed so as to sandwich a second pressing region 65A, which is a region outside the two-point broken line illustrated in multilayer body 31E, in the Z-direction. Second pressing region 65A is located at least in a direction opposite to inner end 57 on the side of through-hole 36 in planar view, and includes outer end 58 that is a part of multilayer body 31E.

Subsequently, the pair of frame plates 62A is disposed so as to sandwich multilayer body 31E in the Z-direction. An opening larger than first pressing elastic member 61A is provided in frame plates 62A. Furthermore, frame plate 62A is disposed in a region excluding first pressing region 60A and second pressing region 65A in multilayer body 31E. Thus, frame plate 62A, first pressing elastic member 61A, and second pressing elastic member 64A do not overlap each other in planar view from the Z-direction. Furthermore, the pair of pressing members 63A is prepared so as to sandwich first pressing elastic member 61A, second pressing elastic member 64A, and frame plate 62A in the Z-direction.

The third step of the method for manufacturing laminate coil 30E of the second embodiment will be described below. In the third step, first pressing elastic member 61A, second pressing elastic member 64A, and frame plate 62A are pressed in the Z-direction by applying the pressure between the pair of pressing members 63A using a pressing machine or the like. Thus, the pressure required for forming laminate coil 30E is applied to multilayer body 31E.

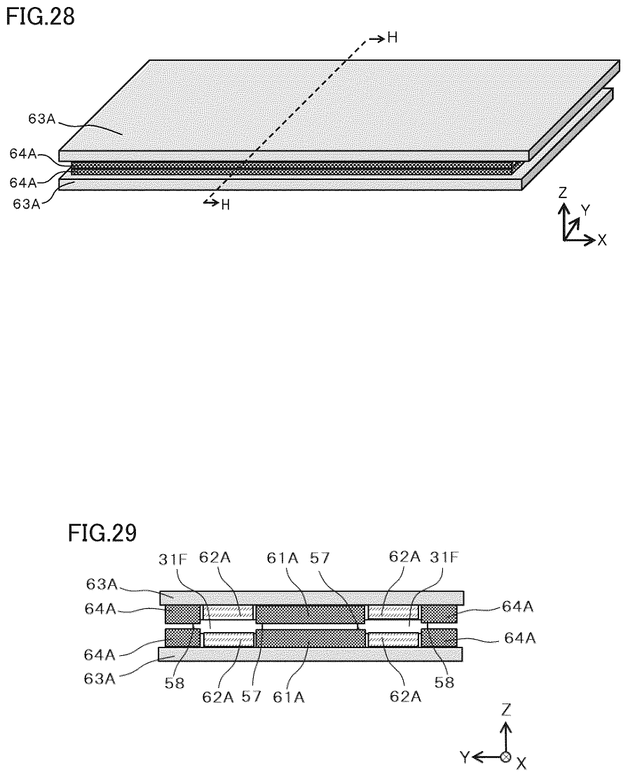

FIG. 28 illustrates the state in which the pressure required for forming laminate coil 30E is applied to multilayer body 31E using first pressing elastic member 61A, second pressing elastic member 64A, frame plate 62A, and pressing member 63A in the Z-direction that is the multilayer direction of the multilayer body. FIG. 29 is a schematic sectional view taken along a sectional line H-H in FIG. 28. As illustrated in FIG. 29, the pair of first pressing elastic members 61A sandwiches inner end 57 that is a part of multilayer body 31E by applying the pressure between the pair of pressing members 63A, and applies the pressure in the Z-direction. In addition, the pair of second pressing elastic members 64A sandwiches outer end 58 that is a part of multilayer body 31E, and presses outer end 58 in the Z-direction. Furthermore, the pair of frame plates 62A sandwiches a part of a region except for inner end 57 and outer end 58 in multilayer body 31E, and presses the part of the region in the Z direction.

The fourth step of the method for manufacturing laminate coil 30E of the second embodiment will be described below. In the fourth step, multilayer body 31E is heated from 70 degrees to 150 degrees while the pressure is applied to multilayer body 31E in FIGS. 28 and 29. The adhesive member applied to each of multilayer insulating members 32 is cured by this heating. Thus, at inner end 57 of multilayer body 31E, multilayer insulating members 32 that are adjacent to each other in the Z-direction that is the multilayer direction of the multilayer body and protrude to through-hole 36 are bonded to each other. Furthermore, at outer end 58 of multilayer body 31E, multilayer insulating members 32 that are adjacent to each other in the Z-direction and protrude outward in the direction opposite to through-hole 36 are bonded to each other.

Here, the third step and the fourth step in the method for manufacturing laminate coil 30E of the second embodiment may be simultaneously performed. Specifically, for example, multilayer body 31E is sandwiched between the pair of pressing members 63A, the pair of frame plates 62A, the pair of first pressing elastic members 61A, and the pair of second pressing elastic members 64A that are heated, and the pressure is applied to multilayer body 31E in the Z-direction. In this manner, the pressure and heat required for forming laminate coil 30E are applied to multilayer body 31. Thus, at inner end 57 of multilayer body 31E, the plurality of multilayer insulating members 32 that protrude to through-hole 36 and are adjacent in the Z-direction can be bonded to each other. Furthermore, at outer end 58 of multilayer body 31E, multilayer insulating members 32 that are adjacent to each other in the Z-direction and protrude outward can be bonded to each other.

Thus, inside end 26 and outside end 27 of each of first coil 20, second coil 21, and third coil 22 in planar view are sealed by the plurality of multilayer insulating members 32. In addition, each of the plurality of multilayer insulating members 32 can be bonded to each of first coil 20, second coil 21, and third coil 22. Thus, laminate coil 30E is formed.

At this point, first pressing elastic member 61A and second pressing elastic member 64A used in the method for manufacturing laminate coil 30E of the second embodiment are formed using, for example, foamed silicone, foamed urethane, or silicone rubber. As described above, multilayer insulating member 32 can be prevented from being damaged using first pressing elastic member 61A and second pressing elastic member 64A at inner end 57 and outer end 58 of multilayer body 31E. Because first pressing elastic member 61A and second pressing elastic member 64A are deformed following the shape of multilayer body 31E, in the case where the number of laminated coils is changed, when the width of the flat conductor of the coil on the XY-plane is changed, and when the thickness of the flat conductor is changed, the plurality of multilayer insulating members 32 can be bonded to each other without any damage or gap.

At this point, pressing member 63A is formed of a material having high thermal conduction, such as aluminum or a metal containing iron. Thus, the heat required for curing the adhesive can be efficiently applied to multilayer body 31E. Frame plate 62A is made of a material having high thermal conductivity, such as aluminum or a metal containing iron. Thus, the heat required for curing the adhesive can be efficiently applied to multilayer body 31E. In addition, the pair of frame plates 62A applies the pressure to multilayer body 31E in the Z-direction, so that the displacement of the coil can be prevented.

As described above, even in inner end 57 and outer end 58 of multilayer body 31E that is difficult to seal without breakage or gaps due to the shape characteristic such as many curved portions, each of the plurality of multilayer insulating members 32 can be bonded without gaps using the method for manufacturing laminate coil 30E of the second embodiment. Thus, inside end 26 and outside end 27 of each of first coil 20, second coil 21, and third coil 22 can be shut tightly. In other words, inside end 26 and outside end 27 of each of first coil 20, second coil 21, and third coil 22 can be sealed by multilayer insulating member 32. Furthermore, the deterioration of the characteristic of coil device 101E due to the short circuit between the coil and the core can be prevented when laminate coil 30E of the second embodiment is used for coil device 101E.

### First Modification of Second Embodiment

A laminate coil 30F according to a first modification of the second embodiment and a coil device 101F including the laminate coil 30F of the first modification of the second embodiment will be described below. In the first modification of the second embodiment, only portions in the configuration different from the first embodiment will be described. In addition, the same reference numerals are used for the same or corresponding configurations as those in the first embodiment, and the description thereof will be omitted. Here, coil device 101F is not illustrated.

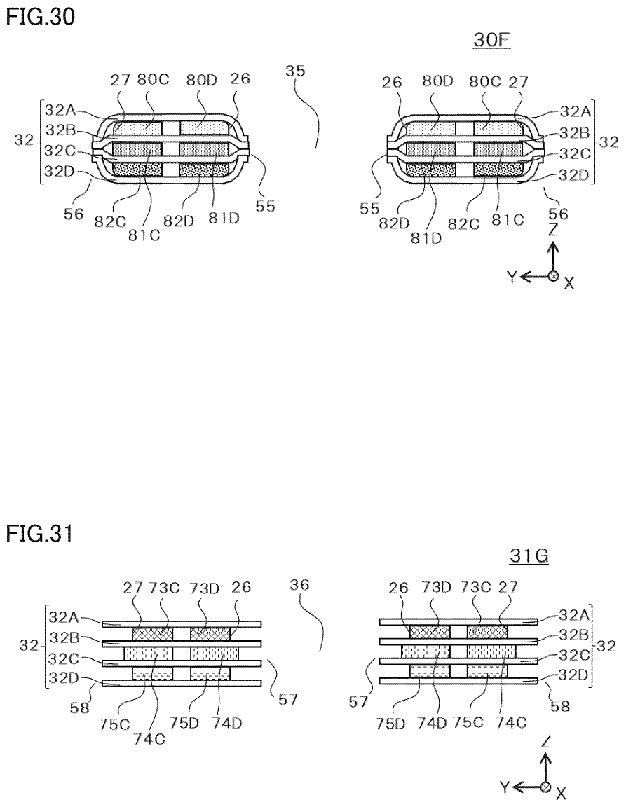

FIG. 30 is a schematic sectional view illustrating laminate coil 30F of the first modification of the second embodiment. In laminate coil 30F, first multilayer insulating member 32A, a fourteenth coil 80, second multilayer insulating member 32B, a fifteenth coil 81, third multilayer insulating member 32C, a sixteenth coil 82, and fourth multilayer insulating member 32D are laminated in this order in the Z-direction that is the multilayer direction. In other words, each of fourteenth coil 80, fifteenth coil 81, and sixteenth coil 82 is disposed so as to be sandwiched between the plurality of multilayer insulating members 32, and is laminated in the Z-direction.

At inner end 55 of laminate coil 30F, the plurality of multilayer insulating members 32 adjacent to each other are bonded to each other. Thus, inside end 26 of each of fourteenth coil 80, fifteenth coil 81, and sixteenth coil 82 is shut tightly by the plurality of multilayer insulating members 32. In other words, inside end 26 of each of fourteenth coil 80, fifteenth coil 81, and sixteenth coil 82 is sealed by the plurality of multilayer insulating members 32.

Furthermore, in planar view, at outer end 56 of laminate coil 30F, the plurality of multilayer insulating members 32 adjacent to each other in the Z-direction are bonded to each other. Thus, outside end 27 of each of fourteenth coil 80, fifteenth coil 81, and sixteenth coil 82 is shut tightly by the plurality of multilayer insulating members 32. In other words, outside end 27 of each of fourteenth coil 80, fifteenth coil 81, and sixteenth coil 82 is sealed by the plurality of multilayer insulating members 32.

As illustrated in FIG. 30, in laminate coil 30F of the first modification of the second embodiment, in fourteenth coil 80 and sixteenth coil 82 disposed at both ends in the Z-direction that is the multilayer direction, inside end 26 and outside end 27 and at least the outside corner in the Z-direction are chamfered and rounded. Accordingly, when multilayer insulating members 32 are bonded to each other, the breakage of multilayer insulating member 32 can be prevented at inner end 55 and outer end 56 of laminate coil 30F.

As described above, in inner end 55 and outer end 56 of laminate coil 30F of the first modification of the second embodiment, each of the plurality of multilayer insulating members 32 is bonded without breakage or gap. That is, inside end 26 and outside end 27 of each of fourteenth coil 80, fifteenth coil 81, and sixteenth coil 82 are shut tightly. In other words, inside end 26 and outside end 27 of each of fourteenth coil 80, fifteenth coil 81, and sixteenth coil 82 are sealed by the plurality of multilayer insulating members 32. Thus, coil device 101F including laminate coil 30F of the first modification of the second embodiment can prevent the degradation of the characteristic due to the short circuit between the coil and the core.

### Second Modification of Second Embodiment

A laminate coil 30G according to a second modification of the second embodiment and a coil device 101G including laminate coil 30G of the second modification of the second embodiment will be described below. In the second modification of the second embodiment, only portions in the configuration different from the first embodiment will be described. In addition, the same reference numerals are used for the same or corresponding configurations as those in the first embodiment, and the description thereof will be omitted. Here, coil device 101G is not illustrated.

FIG. 31 is a schematic sectional view illustrating a configuration of a multilayer body 31G of the second modification of the second embodiment. In multilayer body 31G, first multilayer insulating member 32A, eighth coil 73, second multilayer insulating member 32B, ninth coil 74, third multilayer insulating member 32C, tenth coil 75, and fourth multilayer insulating member 32D are laminated in this order in the Z-direction. In other words, each of eighth coil 73, ninth coil 74, and tenth coil 75 is disposed so as to be sandwiched between the plurality of multilayer insulating members 32, and is laminated in the Z-direction.

As illustrated in FIG. 31, at inner end 57 of multilayer body 31G, each of multilayer insulating members 32 protrudes from inside end 26 of each of eighth coil 73, ninth coil 74, and tenth coil 75 to through-hole 36. Furthermore, the protruding length from inside ends 26 of eighth coil 73 and tenth coil 75 to through-hole 36 of each of first multilayer insulating member 32A and fourth multilayer insulating member 32D provided at both ends in the Z-direction that is the multilayer direction of multilayer body 31G is provided to be longer than the protruding length from inside end 26 of ninth coil 74 to through-hole 36 of each of second multilayer insulating member 32B and third multilayer insulating member 32C other than first multilayer insulating member 32A and fourth multilayer insulating member 32D.

Furthermore, each of multilayer insulating members 32 protrudes outward from outside end 27 of through-hole 36 of each of eighth coil 73, ninth coil 74, and tenth coil 75 at outer end 58 of multilayer body 31G. Furthermore, the protruding length of each of first multilayer insulating member 32A and fourth multilayer insulating member 32D provided at both ends in the Z-direction of multilayer body 31G from outside end 27 of eighth coil 73 or tenth coil 75 to the outside is longer than the protruding length of other second multilayer insulating member 32B and third multilayer insulating member 32C from outside end 27 of ninth coil 74 to the outside.

In the second modification of the second embodiment, the protruding length of multilayer insulating member 32 is changed by changing the width of the flat conductor of each of eighth coil 73, ninth coil 74, and tenth coil 75. Specifically, for example, in multilayer body 31G, the width of the flat conductor of each of eighth coil 73 and tenth coil 75 provided at both ends in the Z-direction of multilayer body 31G is smaller than the width of the flat conductor of ninth coil 74.

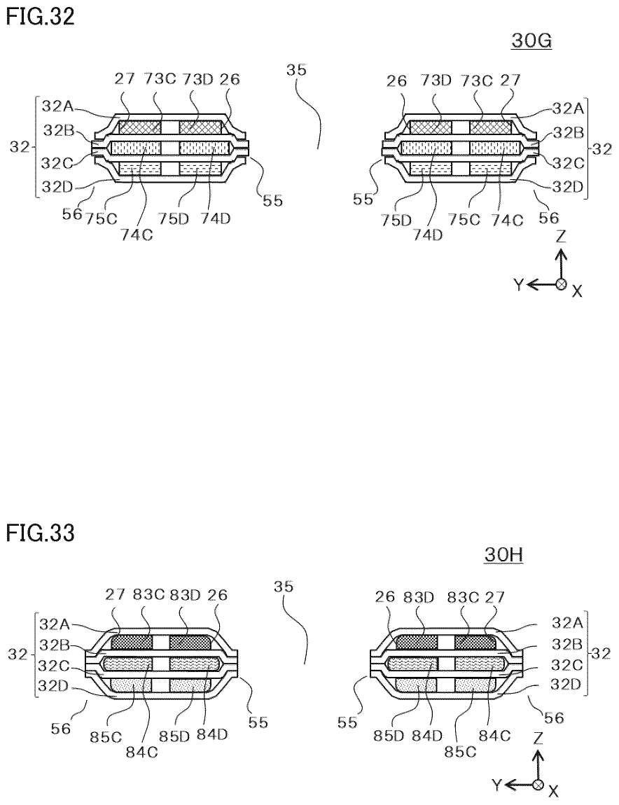

FIG. 32 is a schematic sectional view of laminate coil 30G. In laminate coil 30G, first multilayer insulating member 32A, eighth coil 73, second multilayer insulating member 32B, ninth coil 74, third multilayer insulating member 32C, tenth coil 75, and fourth multilayer insulating member 32D are laminated in this order in the Z-direction that is the multilayer direction. In other words, each of eighth coil 73, ninth coil 74, and tenth coil 75 is disposed so as to be sandwiched between the plurality of multilayer insulating members 32, and is laminated in the Z-direction.

At inner end 55 of laminate coil 30G, the plurality of multilayer insulating members 32 adjacent to each other in the Z-direction are bonded to each other. Thus, inside end 26 of each of eighth coil 73, ninth coil 74, and tenth coil 75 is shut tightly by the plurality of multilayer insulating members 32. In other words, inside end 26 of each of eighth coil 73, ninth coil 74, and tenth coil 75 is sealed by the plurality of multilayer insulating members 32.

In outer end 56 of laminate coil 30G, the plurality of multilayer insulating members 32 adjacent to each other in the Z-direction are bonded to each other. Thus, outside end 27 of each of eighth coil 73, ninth coil 74, and tenth coil 75 is shut tightly by the plurality of multilayer insulating members 32. In other words, outside end 27 of each of eighth coil 73, ninth coil 74, and tenth coil 75 is sealed by the plurality of multilayer insulating members 32.

In laminate coil 30G of the second modification of the second embodiment, as illustrated in FIG. 32, the width of the flat conductor of each of eighth coil 73 and tenth coil 75 disposed at both ends in the Z-direction is smaller than the width of the flat conductor of ninth coil 74 disposed in the central portion except for both ends. In other words, in the Z-direction, the width of the flat conductor of ninth coil 74 disposed in the central portion except for both ends is larger than the width of the flat conductor of each of eighth coil 73 and tenth coil 75 at both ends.

Accordingly, when multilayer insulating members 32 are bonded to each other, the breakage of multilayer insulating member 32 can be prevented at inner end 55 of laminate coil 30G. Furthermore, when multilayer insulating members 32 are bonded to each other, the breakage of multilayer insulating member 32 can be prevented at outer end 56 of laminate coil 30G. Here, the case where the number of laminated coils is three has been described as an example, but the number of laminated coils may be smaller or larger than three. When the number of laminated coils is more than three, the number of coils disposed in the central portion except both ends is a plurality of layers. In addition, the widths of the flat conductors of the plurality of layers of coils disposed in the central portion may be different from each other.

As described above, in inner end 55 and outer end 56 of laminate coil 30G of the second modification of the second embodiment, the plurality of multilayer insulating members 32 can be bonded to each other without any damage or gap. Inside end 26 and outside end 27 of each of eighth coil 73, ninth coil 74, and tenth coil 75 can be shut tightly. In other words, inside end 26 and outside end 27 of each of eighth coil 73, ninth coil 74, and tenth coil 75 can be sealed by the plurality of multilayer insulating members 32. Thus, coil device 101G including laminate coil 30G of the second modification of the second embodiment can prevent the degradation of the characteristic due to the short circuit between the coil and the core.

### Third Modification of Second Embodiment

A laminate coil 30H according to a third modification of the second embodiment and a coil device 101H including laminate coil 30H of the third modification of the second embodiment will be described below. In the third modification of the second embodiment, only portions in the configuration different from the first embodiment will be described. In addition, the same reference numerals are used for the same or corresponding configurations as those in the first embodiment, and the description thereof will be omitted. Here, coil device 101H is not illustrated.

FIG. 33 is a schematic sectional view illustrating laminate coil 30H of the third modification of the second embodiment. In laminate coil 30H, first multilayer insulating member 32A, a seventeenth coil 83, second multilayer insulating member 32B, an eighteenth coil 84, third multilayer insulating member 32C, nineteenth coil 85, and fourth multilayer insulating member 32D are laminated in this order in the Z-direction that is the multilayer direction. In other words, each of seventeenth coil 83, eighteenth coil 84, and nineteenth coil 85 is disposed so as to be sandwiched between the plurality of multilayer insulating members 32, and is laminated in the Z-direction.

At inner end 55 of laminate coil 30H, the plurality of multilayer insulating members 32 adjacent to each other are bonded to each other. Thus, inside end 26 of each of seventeenth coil 83, eighteenth coil 84, and nineteenth coil 85 is shut tightly by the plurality of multilayer insulating members 32. In other words, inside end 26 of each of seventeenth coil 83, eighteenth coil 84, and nineteenth coil 85 is sealed by the plurality of multilayer insulating members 32.

In outer end 56 of laminate coil 30H, the plurality of multilayer insulating members 32 adjacent to each other in the multilayer direction are bonded to each other. Thus, outside end 27 of each of seventeenth coil 83, eighteenth coil 84, and nineteenth coil 85 is shut tightly by the plurality of multilayer insulating members 32. In other words, outside end 27 of each of seventeenth coil 83, eighteenth coil 84, and nineteenth coil 85 is sealed by the plurality of multilayer insulating members 32.

In laminate coil 30H of the third modification of the second embodiment, as illustrated in FIG. 33, the width of the flat conductor of each of seventeenth coil 83 and nineteenth coil 85 disposed at both ends in the Z-direction is smaller than the width of the flat conductor of eighteenth coil 84 disposed in the central portion except for both ends. In other words, in the Z-direction, the width of the flat conductor of eighteenth coil 84 disposed in the central portion except for both ends is larger than the width of the flat conductor of each of seventeenth coil 83 and nineteenth coil 85 at both ends.

In laminate coil 30H of the third modification of the second embodiment, in seventeenth coil 83 and nineteenth coil 85 disposed at both ends in the Z-direction that is the multilayer direction, inside end 26 and outside end 27 and at least the outside corner in the Z-direction are chamfered and rounded. Furthermore, in eighteenth coil 84 disposed in the central portion except for both ends in the Z-direction, corners of inside end 26 and outside end 27 in planar view may be chamfered and rounded. Accordingly, when multilayer insulating members 32 are bonded to each other, the breakage of multilayer insulating member 32 can be prevented at inner end 55 and outer end 56 of laminate coil 30H.

Accordingly, in inner end 55 and outer end 56 of laminate coil 30H of the third modification of the second embodiment, the plurality of multilayer insulating members 32 can be bonded to each other without any damage or gap. Here, the case where the number of laminated coils is three has been described as an example, but the number of laminated coils may be smaller or larger than three. When the number of laminated coils is more than three, the number of coils disposed in the central portion except both ends is a plurality of layers. In addition, the widths of the flat conductors of the plurality of layers of coils disposed in the central portion may be different from each other.

Thus, inside end 26 and outside end 27 of each of seventeenth coil 83, eighteenth coil 84, and nineteenth coil 85 can be shut tightly. In other words, inside end 26 and outside end 27 of each of seventeenth coil 83, eighteenth coil 84, and nineteenth coil 85 can be sealed using multilayer insulating member 32. Thus, coil device 101H including laminate coil 30H of the third modification of the second embodiment can prevent the degradation of the characteristic due to the short circuit between the coil and the core.

### REFERENCE SIGNS LIST

1: power conversion device; 2: inverter circuit; 3: transformer circuit; 4: rectifier circuit; 5: smoothing circuit; 6: control circuit; 7a, 7b, 7c, 7d: switching element; 8a, 8b, 8c, 8d: diode; 9a, 9b: capacitor; 10: core; 10A: upper core; 10B: lower core; 10C: void portion; 10E: wound portion; 20: first coil; 21: second coil; 22: third coil; 23A, 23B, 24A, 24B: connection terminal; 25: fourth coil; 26: inside end; 27: outside end; 30, 30A, 30B, 30C, 30D, 30E, 30F, 30G, 30H: laminate coil; 31, 31C, 31E, 31G: multilayer body; 32, 32A, 32B, 32C, 32D: multilayer insulating member; 33: insulating sealing member; 34: inter-conductor insulating member; 35, 36: through-hole; 40: support; 42: protrusion member; 43: heat transfer member; 52: fixing member; 55, 57: inner end; 56, 58: outer end; 60, 60A, 65A: pressing region; 61, 61A, 64A: pressing elastic member; 62, 62A: frame plate; 63, 63A: pressing member; 70: fifth coil; 71: sixth coil; 72: seventh coil; 73: eighth coil; 74: ninth coil; 75: tenth coil; 76: eleventh coil; 77: twelfth coil; 78: thirteenth coil; 80: fourteenth coil; 81: fifteenth 5 coil; 82: sixteenth coil; 83: seventeenth coil; 84: eighteenth coil; 85: nineteenth coil; 90: screw; 101, 101A, 101B, 101C, 101D, 101E, 101F, 101G, 101H, 102, 103, 104: coil device; 110: input terminal; 111: output terminal

1. A method for manufacturing a laminate coil formed by laminating a first coil, a second coil, a third coil, a first multilayer insulating member, a second multilayer insulating member, a third multilayer insulating member, and a fourth multilayer insulating member, each of the first coil, the second coil, and the third coil being formed of a flat conductor, the method comprising:
(a) sequentially laminating the first multilayer insulating member, the first coil, the second multilayer insulating member, the second coil, the third multilayer insulating member, the third coil, and the fourth multilayer insulating member, and forming a multilayer body so as to include a through-hole penetrating, in a multilayer direction, into the first coil, the second coil, and the third coil in planar view;
(b) disposing a pair of first pressing elastic members so as to sandwich an inner end of the multilayer body in the multilayer direction, the inner end being located on a through-hole side and, further, preparing a pair of pressing members so as to sandwich the pair of first pressing elastic members; and
(c) applying pressure between the pair of pressing members to bond, at the inner end, the first multilayer insulating member and the second multilayer insulating member, the second multilayer insulating member and the third multilayer insulating member, and the third multilayer insulating member and the fourth multilayer insulating member, and sealing an inside end of each of the first coil, the second coil, and the third coil, the inside end being located on the through-hole side, wherein
in the (b) a pair of frame plates made of metal are disposed between the multilayer body and the pair of pressing members so as to sandwich the multilayer body in the n uitilayer direction,
in planar view, the pair of first pressing elastic members are disposed in a region including the through hole and the inner end,
in planar view, the pair of frame plates are disposed to surround the pair of first pressing elastic members, and
in the (c) the pressure is applied between the pair of pressing members to apply the pressure to the multilayer body sandwiched between the pair of first pressing elastic members and the pair of frame plates, and each of the first coil; the second and the third coil is bonded to the first multilayer insulating member, the second multilayer insulating member, the third multilayer insulating member, and the fourth multilayer insulating member.

2. (canceled)

3. The method for manufacturing a laminate coil according to claim 1, wherein
in the (b), a pair of second pressing elastic members is disposed between the multilayer body and the pair of pressing members so as to sandwich, in the multilayer direction, an outer end located in a direction opposite to the inner end in the multilayer body, and
in the (c), the first multilayer insulating member and the second multilayer insulating member, the second multilayer insulating member and the third multilayer insulating member, and the third multilayer insulating, member and the fourth multilayer insulating member, in the outer end, are bonded by applying the pressure between the pair of pressing members, and an outside end located in a direction opposite to the inside end is sealed in each of the first coil, the second coil, and the third coil.

4. The method for manufacturing a laminate coil according to claim 1 wherein, in the (a), an adhesive member is applied to each of surfaces of the first multilayer insulating member, the second multilayer insulating member, the third multilayer insulating member, and the fourth multilayer insulating member the surfaces facing the first the second coil, and the third coil.

5. The method for manufacturing a laminate coil according to claim 4, wherein
the adhesive member is a thermosetting pressure-sensitive adhesive or adhesive, and,
in the (c), the first multilayer insulating member and the second multilayer insulating member, the second multilayer insulating member and the third multilayer insulating member, and the third multilayer insulating member and the fourth multilayer insulating member are bonded to each other by heating the multilayer body while pressure is applied to the multilayer body.

6. The method for manufacturing a laminate coil according to claim 1 wherein, in the multilayer body in the (a), a length of the first multilayer insulating member protruding from the inside end of the first coil to the through-hole is longer than a length of the second multilayer insulating member protruding from the inside end of the second coil to the through-hole.

7. The method for manufacturing a laminate coil according to claim 6, wherein, in the multilayer body in the (a), a width of the first multilayer insulating member is larger than a width of the second multilayer insulating member.

8. A laminate coil comprising:
a plurality of coils formed of flat conductors; and
a plurality of multilayer insulating members,
wherein the laminate coil, in which each of the plurality of coils is laminated so as to be sandwiched between the plurality of multilayer insulating members, is formed so as to include a through-hole penetrating, in a multilayer direction, into the plurality of coils in planar view,
the plurality of multilayer insulating members adjacent to each other in the multilayer direction are bonded to each other at an inner end located on a through-hole side, and an inside end located on the through-hole side in each of the plurality of coils is sealed,
the laminate coil is a multilayer body in which a first multilayer insulting member, a first coil, a second multilayer insulating member, a second coil, third multilayer insulating member a third coil, and a fourth multilayer insulating member are sec laminated, and
the inside end of the second coil is located closer to the through hole, relative to inside end of each of the first coil and the third coil.

9. The laminate coil according to claim 8, wherein in an outer end located in a direction opposite to the inner end, an outside end located in a direction opposite to the inside end in the plurality of coils is sealed by an insulating sealing member.

10. The laminate coil according to claim 8, wherein,
at an outer end located in a direction opposite to the inner end, the plurality of multilayer insulating members adjacent to each other in the multilayer direction are bonded to each other, and an outside end of each of the plurality of coils is sealed, the outside end being located in a direction opposite to the inside end, and
the outside end of the second coil is located outside relative to the outside end of each of the first coil and the third coil.

11. The laminate coil according to claim 8, wherein the plurality of coils include a first-width coil formed of a flat conductor having a first width, second-width coil formed of a flat conductor having a second width different from the first width and a third-width coli formed of a flat conductor having a third width different from the first width.

12.-14. (canceled)

15. A laminate coil comprising:
a plurality of coils formed of flat conductors; and
a plurality of multilayer insulating members,
wherein the laminate coil, in which each of the plurality of coils is laminated so as to be sandwiched between the plurality of multilayer insulating members, is formed so as to include a through-hole penetrating, in a multilayer direction, into the plurality of coils in planar view,
the plurality of multilayer insulating members adjacent to each other in the multilayer direction are bonded to each other at an inner end located on a through-hole side, and an inside end located on the through-hole side in each of the plurality of coils is sealed, and
in each of a coil located at an upper end and a coil located at a lower end in the multilayer direction that are included in the plurality of coils, at least an outside corner in the multilayer direction is chamfered and rounded at least at the inside end.

16. The laminate coil according to claim 15, wherein in an outer end located in a direction opposite to the inner end, an outside end located in a direction opposite to the inside end in the plurality of coils is sealed by an insulating sealing member.

17. The laminate coil according to claim 15, wherein, at an outer end located in a direction opposite to the inner end, the plurality of multilayer insulating members adjacent to each other in the multilayer direction are bonded to each other, and an outside end of each of the plurality of coils is sealed, the outside end being located in a direction opposite to the inside end.

18. The laminate coil according to claim 15, wherein the plurality of coils include a first-width coil formed of a flat conductor having a first width, and a second-width coil formed of a flat conductor having a second width different from the first width.

19. The laminate coil according to claim 15, wherein, in at least one of the plurality of coils, an inner corner portion of the flat conductor in the inside end is rounded.

20. A coil device comprising:
the laminate coil according to claim 8; and
a core,
wherein the laminate coil is disposed so as to wind around the core.

21. A power conversion device comprising:
a transformer circuit to include the coil device according to claim 20;
an inverter circuit to include a plurality of switching elements; and
a control circuit to control the inverter circuit.
